(19) United States
(12) Patent Application Publication
(10) Pub. No.: US 2001/0047362 A1
(43) Pub. Date: Nov. 29, 2001

(54) Automated web site publishing and design system

(76) Inventor: Matthew Comroe, Pittsburgh, PA (US)

Correspondence Address: Jon D. Grossman, DICKSTEIN SHAPIRO MORIN & OSHINSKY LLP, 2101 L Street NW, Washington, DC, 20037-1526, US

(21) Appl. No.: 09/749,556

(22) Filed: Dec. 28, 2000

Related U.S. Application Data
(60) Provisional application No. 60/173,551, filed on Dec. 30, 1999.

(51) Int. Cl. G06F 17/30; G06F 15/16; G09G 5/00

(52) U.S. Cl. 707/104.1; 707/10; 709/204; 345/733

(57) ABSTRACT

The present invention provides a method of publishing a newsletter over a computer network comprising displaying headlines and abstracts of articles; displaying category listings that reference each category; displaying article archives that reference each article in the archive; searching articles by keywords; subscribing e-mail addresses to distribution lists; adding, modifying, and deleting articles; converting added and modified articles into HTML; and adding, modifying, or removing any references to an article when it is added, modified, or deleted.

### FIELD OF THE INVENTION

The present invention relates to the publishing of a web site and more particularly to a method and apparatus for a person with no knowledge of web page design to publish materials and administrate the publishing of online materials.

### BACKGROUND OF THE INVENTION

Web pages, like any other piece of software, have to be written in a programming language, known as HyperText Markup Language (“HTML”). Before a person can write a web page, he or she must acquire, at a minimum, a rudimentary understanding of HTML. As the number of people accessing the Internet drastically rises, more people want to publish web sites—most of whom are not computer programmers and who have no experience writing software. In addition, most companies want to maintain web sites for both the public and employees.

As a result of the growing number of untrained people publishing web sites, many HTML editor programs have been developed to simplify the writing process. HTML editor programs allow a user to create an HTML document on a word-processor platform such as Microsoft Word, Corel WordPerfect, etc. The HTML editor then converts the document into HTML which functionally changes the document into an internet web page. This method allows a web page designer to design a web page without knowing the syntax of HTML. It does not, however, simplify the process of combining many web pages into one interconnected web site. The user still has to know how to create links and how to organize a web site. Each time the web page designer wants to add a new web page to the web site, the new page must be created and then every web page on the web site that the user wants to point to that web page must be modified. In addition, when the user wants to delete a web page from the web site, every page that points to the deleted page must be modified. While it is simpler to create or update a web page in an HTML editor, it does not simplify the maintenance of a web site.

Therefore, there exists a need in the art for a method and apparatus that allows a person with limited knowledge of computer programming and HTML to administrate a web site.

### SUMMARY OF THE INVENTION

The present invention allows a person with no knowledge of HTML to maintain the content of a web site. This allows a company to have a current employee maintain the content of an online company newsletter without providing any additional training to that employee. Once the web site is set up, a person only has to fill out a simple form that is on the web site to post new content to the web site. The new content will be formatted and placed in all of the appropriate places in the web site. This includes any links from drop down menus that should point to the new article. Content is deleted from the web site or modified in the same manner.

It is, therefore, an object of the invention to provide an automated web site formatting system that requires less knowledge of programming to administrate than the prior art.

It is a further object of this invention to provide a computer system publishing program that comprises a computer memory and a search processor with a user interface that includes a searcher, a subscriber, an articles searcher, a category viewer, an article viewer, a headline viewer, and an editor.

It is further an object of this invention that the searcher allows the articles to be searched by text, category, abstract, or by headlines.

It is further an object of this invention that the subscriber adds e-mail addresses to distribution lists.

It is further an object of this invention that the category searcher allows the articles within a category to be searched by text or abstracts.

It is further an object of this invention that the category viewer allows the articles in a category to be viewed.

It is further an object of this invention that the article archive viewer allows old articles to be viewed.

It is further an object of this invention that the headlines viewer allows the headlines of the articles to be viewed.

It is further an object of this invention that the article editor allows the user to edit articles and categories.

It is further an object of this invention that the article editor allows an article to be added, deleted, or modified or allows an image to be added to an article.

It is further an object of this invention that the category editor allows a category to be added, deleted, or modified.

With these and other objects, the present invention provides a method of publishing a newsletter over a computer network comprising displaying headlines and abstracts of articles; displaying category listings that reference each category; displaying article archives that reference each article in the archive; searching articles by keywords; subscribing e-mail addresses to distribution lists; adding, modifying, and deleting articles; converting added and modified articles into HTML; and adding, modifying, or removing any references to an article when it is added, modified, or deleted.

In addition to solving the problem of requiring trained personnel to operate a web site, the present invention also reduces the amount of time it takes to update the information on a web site. A company newsletter can be operated by individuals from various departments who have no knowledge of HTML and who have no contact with each other. It is not necessary to have all of the people adding information to a web site coordinate the changes they are making to the web site.

### BRIEF DESCRIPTION OF THE DRAWINGS

FIG. 1 is an organizational chart for an online newsletter in accordance with a preferred embodiment of the present invention.

FIG. 1a is an illustration of the main web page of an online newsletter created accordance with the preferred embodiment of FIG. 1.

FIG. 2 is an organizational chart for an online newsletter's search articles page in accordance with the preferred embodiment of FIG. 1.

FIG. 2a is an illustration of the search articles page of an online newsletter created in accordance with the preferred embodiment of FIG. 1.

FIG. 3 is an organizational chart for an online newsletter's category page in accordance with the preferred embodiment of FIG. 1.

FIG. 3a is an illustration of the category page of an online newsletter created in accordance with the preferred embodiment of FIG. 1.

FIG. 4 is an organizational chart for an online newsletter's subscribe page in accordance with the preferred embodiment of FIG. 1.

FIG. 4a is an illustration of the subscribe page of an online newsletter that requests an e-mail address created in accordance with the preferred embodiment of FIG. 1.

FIG. 4b is an illustration of the subscribe page of an online newsletter created in accordance with the preferred embodiment of the present invention.

FIG. 5 is an organizational chart for an online newsletter's article archive page in accordance with the preferred embodiment of the present invention.

FIG. 5a is an illustration of the article archive page of an online newsletter created in accordance with the preferred embodiment of the present invention.

FIG. 6 is an organizational chart for an online newsletter's editor's desk in accordance with the preferred embodiment of the present invention.

FIG. 6a is an illustration of the editor's desk of an online newsletter created in accordance with the preferred embodiment of the present invention.

FIG. 6b is an illustration of the delete story page of an online newsletter created in accordance with a preferred embodiment of the present invention.

FIG. 7 is an organizational chart for an online newsletter's add article page in accordance with a preferred embodiment of the present invention.

FIG. 7a is an illustration of the add story page of an online newsletter created in accordance with a preferred embodiment of the present invention.

FIG. 8 is an organizational chart for an online newsletter's set lead article page in accordance with a preferred embodiment of the present invention.

FIG. 8a is an illustration of the set lead article page of an online newsletter created in accordance with a preferred embodiment of the present invention.

FIG. 9 is an organizational chart for an online newsletter's administer categories page in accordance with a preferred embodiment of the present invention.

FIG. 9a is an illustration of the administer categories page of an online newsletter created in accordance with a preferred embodiment of the present invention.

FIG. 10 is an organizational chart for an online newsletter's add category page in accordance with a preferred embodiment of the present invention.

FIG. 10a is an illustration of the add category page of an online newsletter created in accordance with a preferred embodiment of the present invention.

FIG. 11 is an organizational chart for an online newsletter's delete category page in accordance with a preferred embodiment of the present invention.

FIG. 11a is an illustration of the delete category page of an online newsletter created in accordance with a preferred embodiment of the present invention.

FIG. 12 is an organizational chart for an online newsletter's edit category status page in accordance with a preferred embodiment of the present invention.

FIG. 12a is an illustration of the edit category status page of an online newsletter created in accordance with a preferred embodiment of the present invention.

FIGS. 13a-13i illustrate additional editor features of the present invention.

### DETAILED DESCRIPTION OF PREFERRED EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that structural changes may be made and equivalent structures substituted for those shown without departing from the spirit and scope of the present invention.

The invention comprises an apparatus and method for publishing a newsletter over a computer network.

In a preferred embodiment of the system, the web site will be set up on a server. The server will be connected to the a wide area network, such as the Internet or an Intranet. It should be understood that any network may apply. Any user can access the web site from anywhere he or she can connect to the Internet if the user has a password. The server contains the files for the web site and the database. The database archives all of the information for the web site. There are entries for each category, each article, distribution lists, and for the web pages. The category entries each contain a list of articles associated with it. The article entries each contain a category associated with it. The database is set up when the software is installed. It initially has no stories or categories. Once the software is functioning, then the user can modify the database using the Editor's Desk 140.

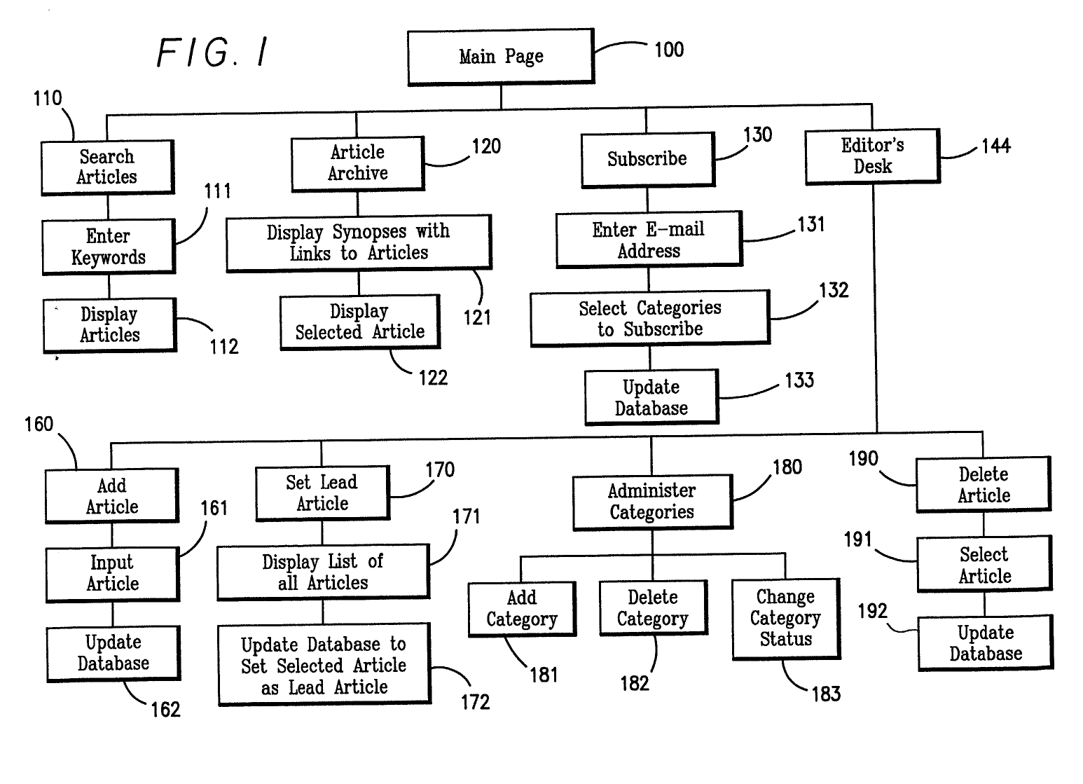

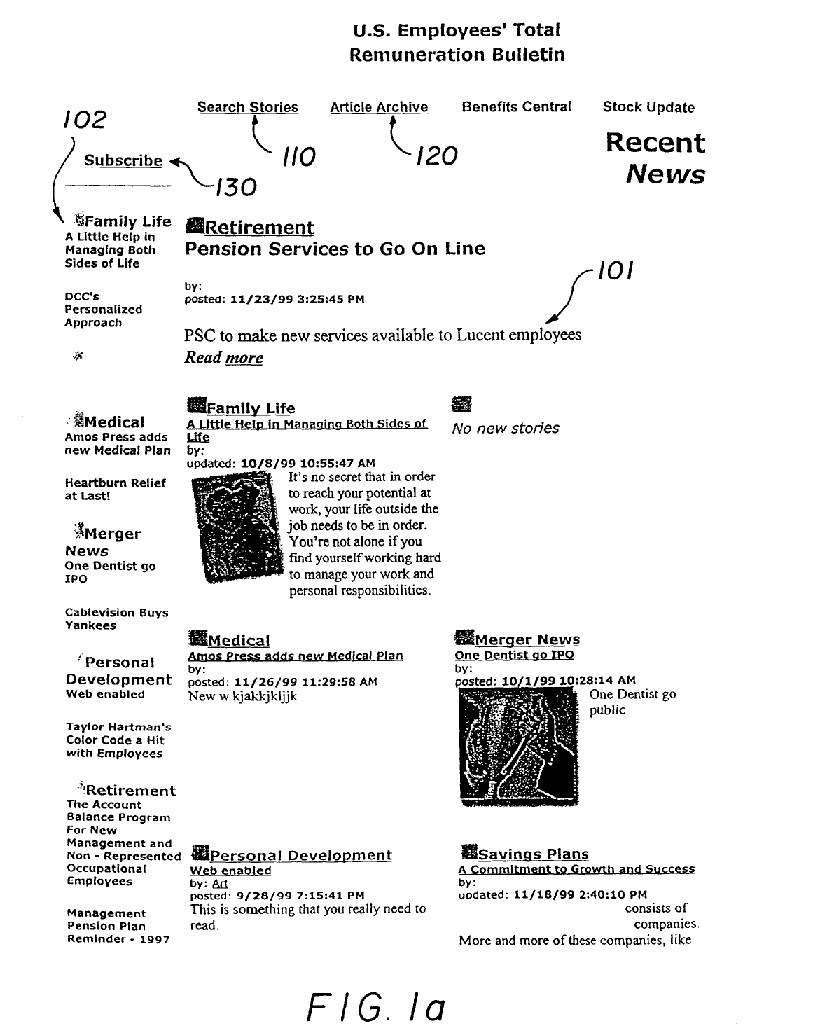

The web page shown in FIG. 1 includes a main page 100 with links to a search articles page 110, an article archive page 120, a subscribe page 130, and an editor's desk page 140. The main page also includes links to headline articles from each category.

The search articles page 110 allows the database of articles to be searched by keywords. The database is searched by the software using SQL. The software transforms the keywords entered into an SQL query. When the search articles link 110 is selected, a web page requesting words to be searched for 111 is displayed. The program then searches the database for articles that have keywords that match. Once the database is searched, a web page is displayed with the title and abstract of every matching article 112. The title of each article is formatted to link to the full text of that article.

The article archive page 120 allows a category to be selected for viewing. A category is a set of related articles. The user sets up the categories for the newsletter. An article will be listed when the category it is associated with is displayed and it is e-mailed to the distribution list of the category it is associated with when it is added. When the article archive link 120 is selected, a menu of every category is displayed. When a category is selected, each article in the selected category is displayed by its title and abstract 121 in the same manner as described above with respect to the search articles module. The title of each article is a link to the full text of that article. Once an article is selected, the full text is displayed 122.

The subscribe page 130 allows an e-mail address to be added to a distribution list. There is a distribution list for each category and audience in the database. When a category or audience is created, the distribution list is empty. Once users have subscribed to the distribution list, each subscriber receives an e-mail of each new article added to that category or specified for that audience. When the subscribe link 130 is selected, a prompt for an e-mail address is displayed 131, which after an e-mail address is entered, a list of categories and audiences are displayed 132. The user can select any of the categories' or audiences' distribution lists to be added to which will in turn cause an automatic update to be made to the database.

The editor's desk page 140 requires any person accessing it to login. Once the user is logged in, the editor's desk page 140 includes links to an add article page 160, a set lead article page 170, and an administer categories page 180. The editor's desk 140 also includes links to allow every article published on the web site to be edited or deleted. The delete article function 190 involves selecting the article to be deleted at 190 step 191 and updating the article database at step 192.

The add articles page 160 prompts the user to enter all of the necessary information for an article 161. Once the article database is updated 162, a link to that article is added to the list of articles for the designated category and the article database is updated. The added article is also e-mailed to the distribution list for the designated category or audience, a link to it is added to the editor's desk 140, and it is added to the list of articles for that category on the set lead article page 170.

The set lead article page 170 allows an article to be set as the lead article. The lead article's title and abstract are displayed more prominently than any other article on the main page 100. When the set lead article link is selected, a list of all of the articles in the database is displayed 171. Once an article is set as the lead article, the main page 100 is changed so that the lead article's title and abstract are displayed prominently. The title of the lead article is a link to the full text of that article. The changes are then stored by the system at step 172.

The administer categories page 180 includes links to add a category, delete a category, and to change the status of each category. When the add category page 181 is selected, the user is prompted to provide a name for the new category. Once all of the information is entered, a link to edit that category's status is added to the administer categories page 180 and its default status is inactive. The new category is also added to the add article page 160.

When the delete category page 182 is selected, a list of categories is displayed. Once a category is selected, the category and all of the articles in it are deleted. All of the links to that category and to any articles in it are deleted from the web site also.

When the change category status page 183 is selected, the status of a category can be changed from active to inactive or inactive to active. If a category is changed from inactive to active, links to that category are added to the main page 100, the article archive page 120, and the subscribe page 130. In addition, the inactive designation on the links to that story on the add new story page 161 and the editor's desk page are removed. If a category is changed from active to inactive, the only links to it that remain are on the administer categories page 180 and the editor's desk page 140. In addition, designations are added to those pages to indicate that the category is inactive.

The web page illustrated in FIG. 1a is a depiction of the web page described for FIG. 1. It is the main page for an online newsletter. There are links to search stories or articles 110, to view the article archive 120, to subscribe to distribution lists 130, and for the editor's desk. There is also a lead article 101 and a list of categories 102.

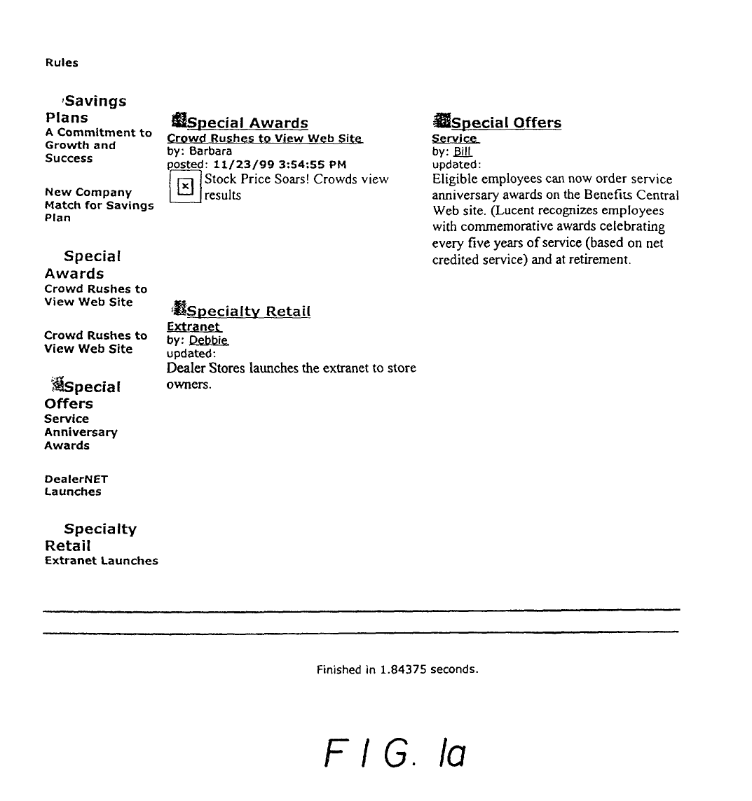

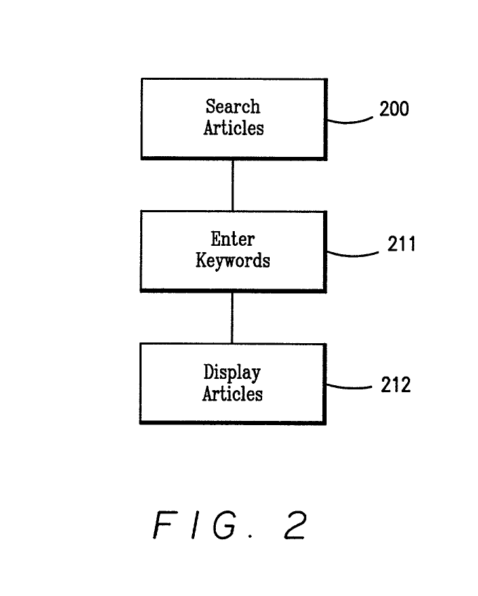

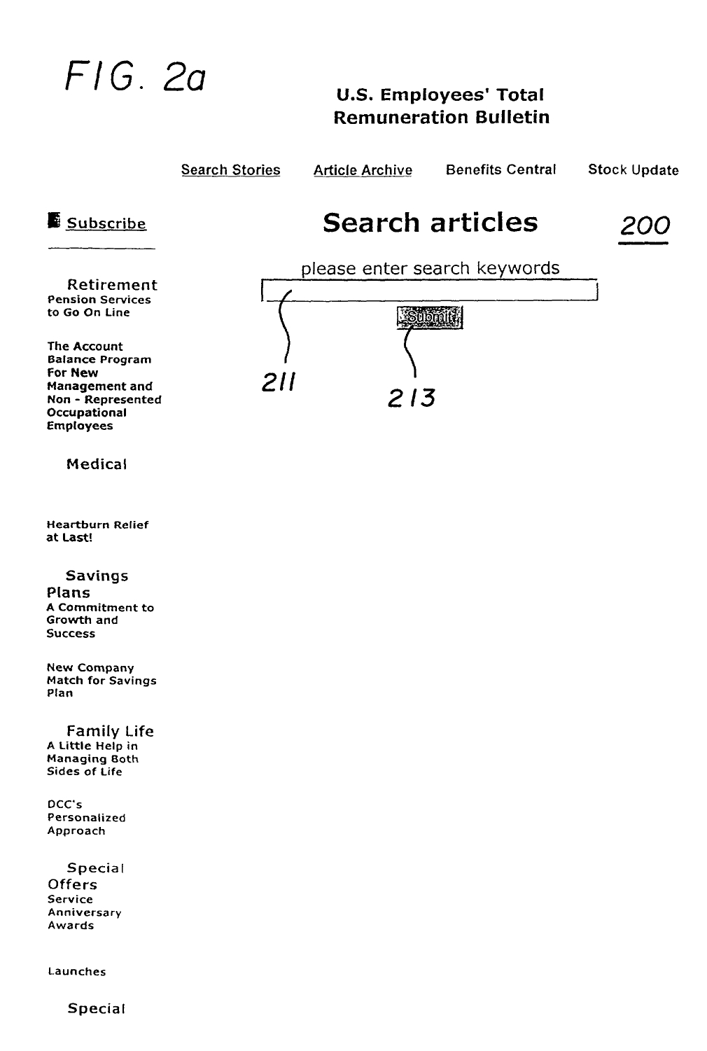

The web page shown in FIG. 2 is a search articles page 200. When it is selected from another web page on the web site, the user is prompted to enter keywords 211. The software converts the keywords entered into a query to the database. The database searches for articles with matching keywords and displays the matching articles 211.

The web page illustrated in FIG. 2a is a depiction of the web page described for FIG. 2. It is the search articles page for an online newsletter. The user would enter keywords 111 and select submit 213.

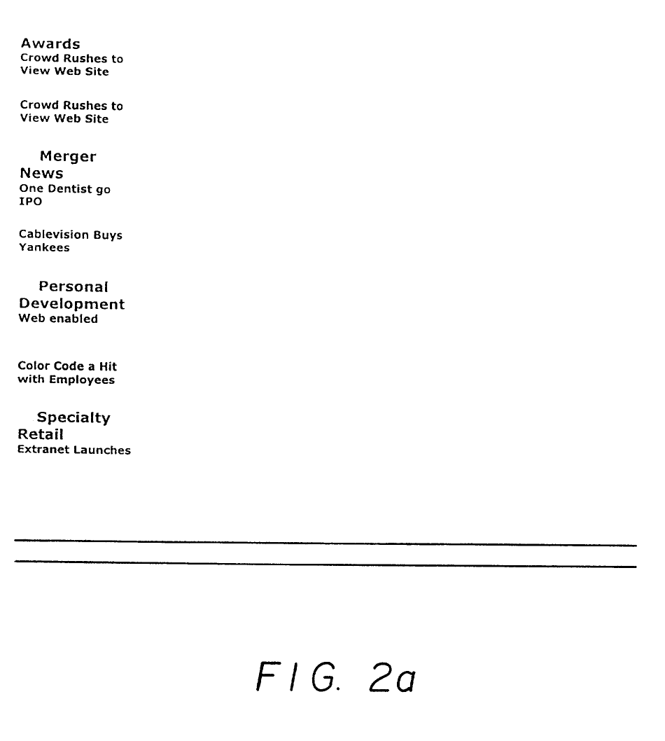

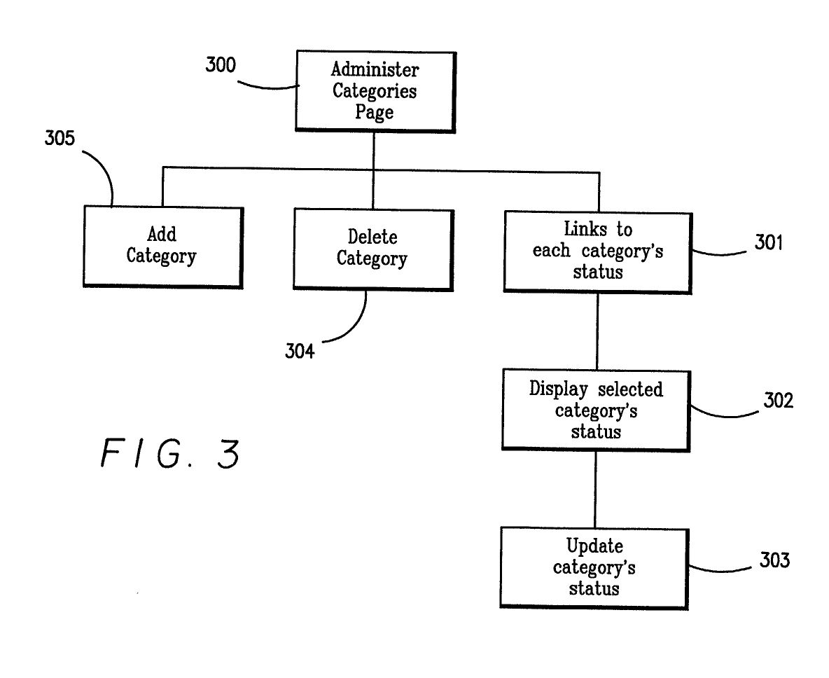

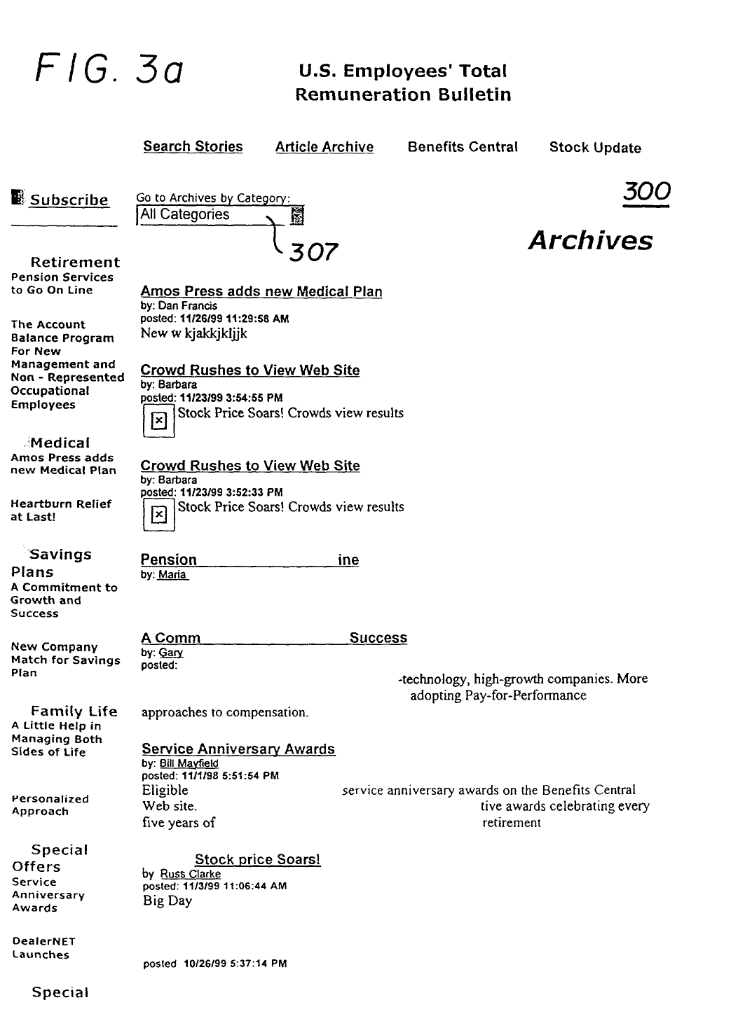

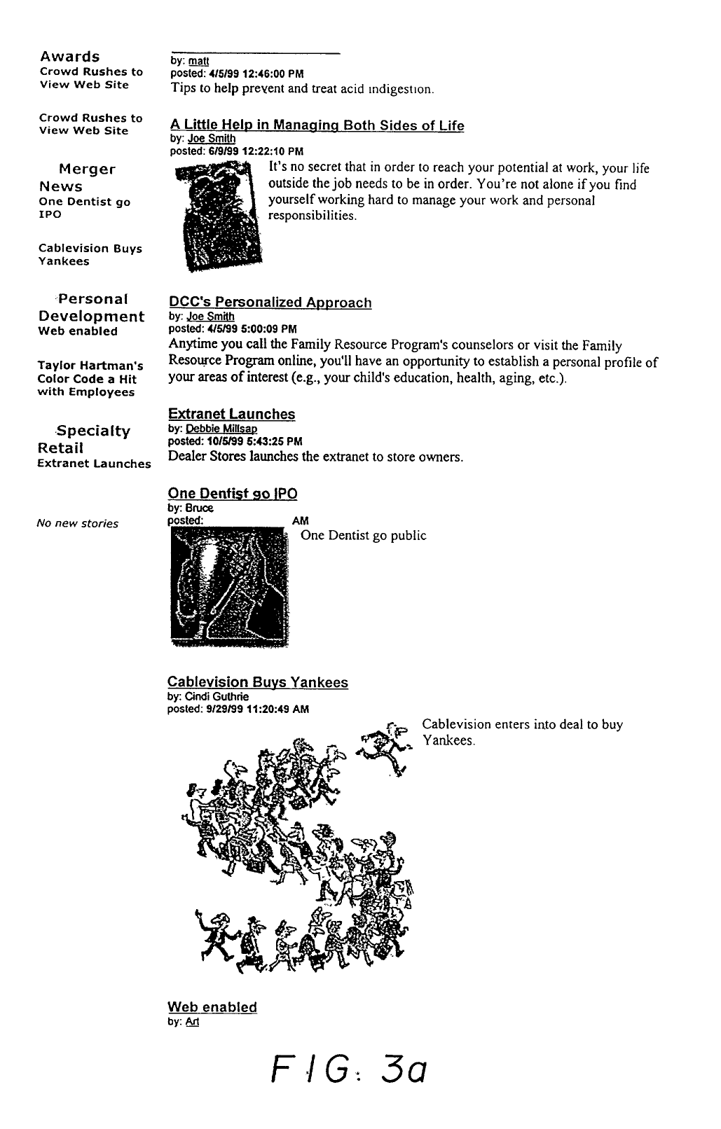

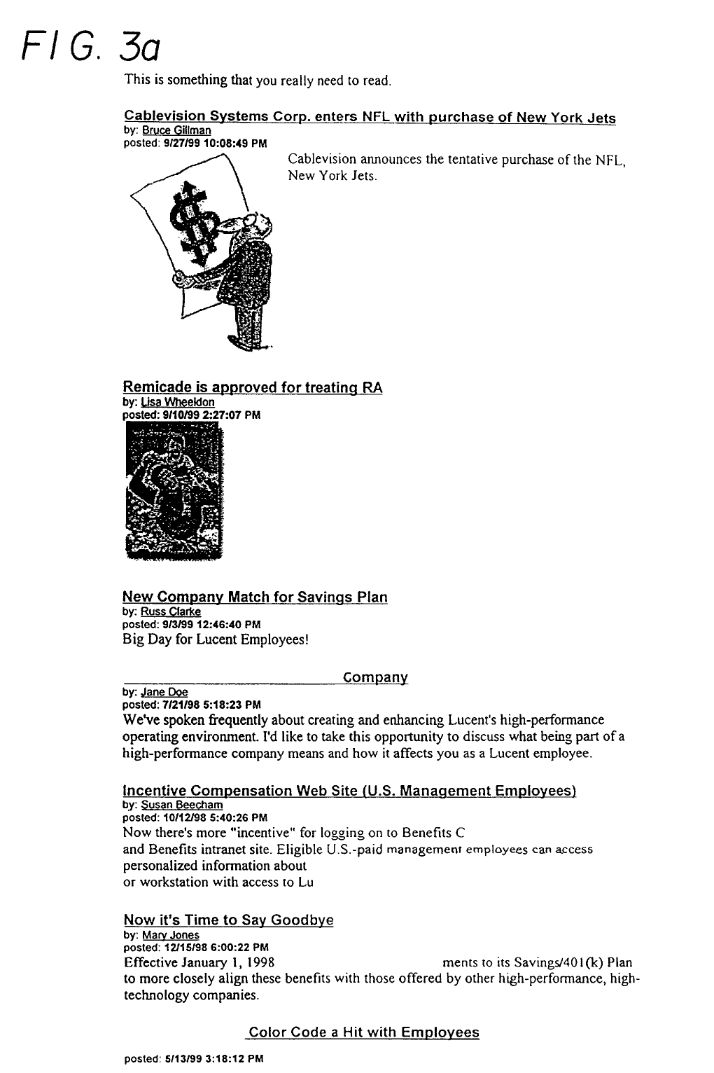

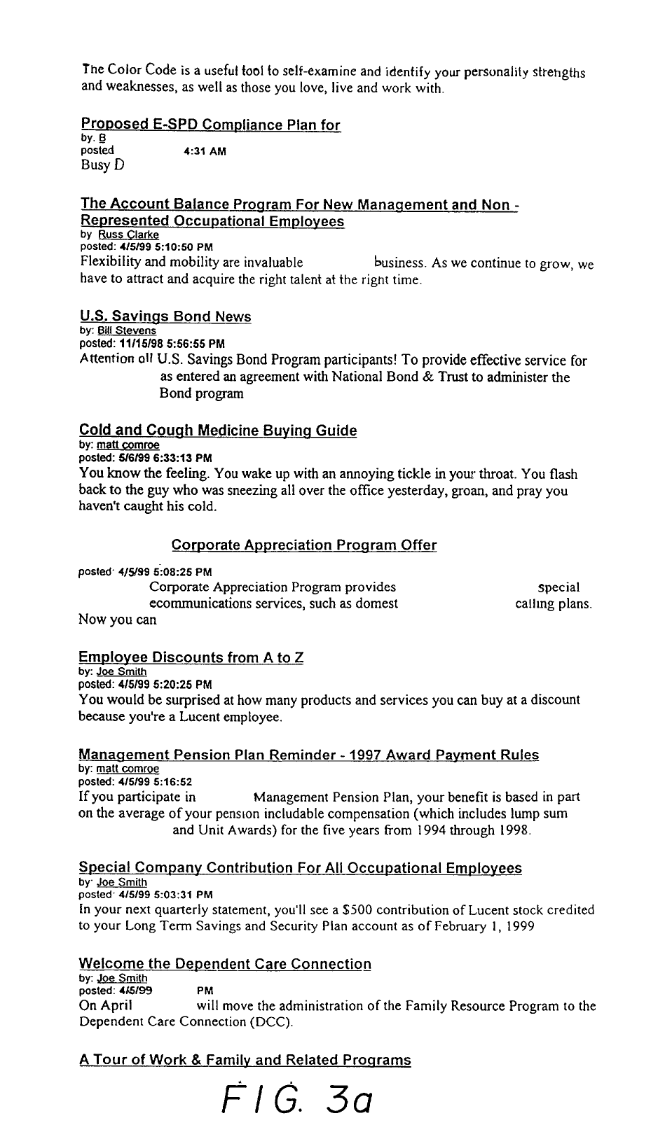

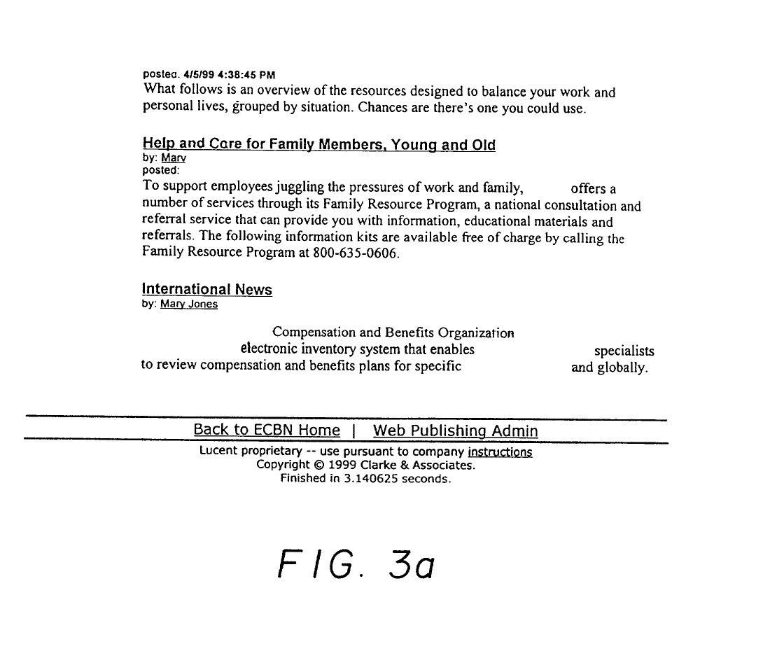

The web page shown in FIG. 3a and the flow diagram in FIG. 3 involves the administer categories page 300. There are links to the article archive for each category on each web page that users without administrative access can view at step 301. The user selects the category to be viewed on that page 302. The software then displays the article archive for the selected category 302. The category status is then updated at step 303.

The web page illustrated in FIG. 3a is a depiction of the web page described for FIG. 3. It is a category page for an online newsletter. Once the user is on the category page, the user can change the category being viewed by selecting a new category from the links 305 or from the drop-down menu 307 which contains a list of all of the categories. In addition, a category can be deleted at step 304.

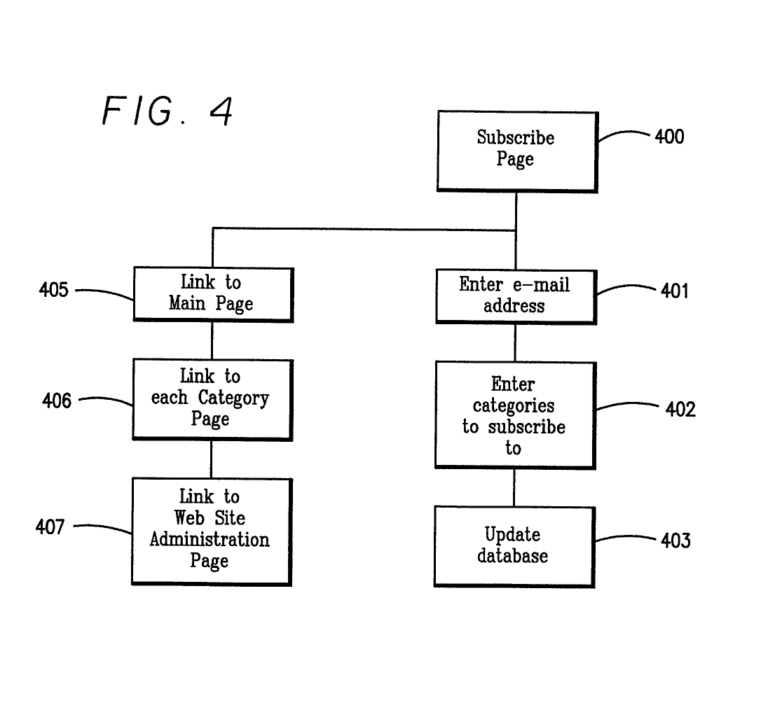

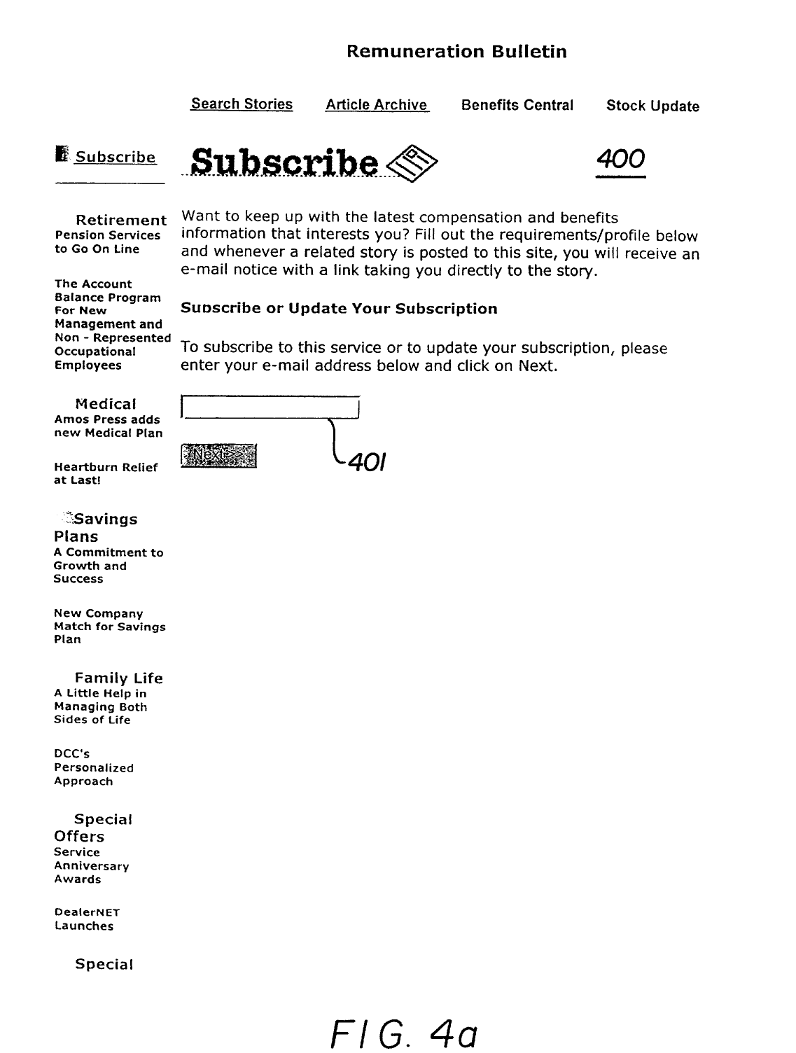

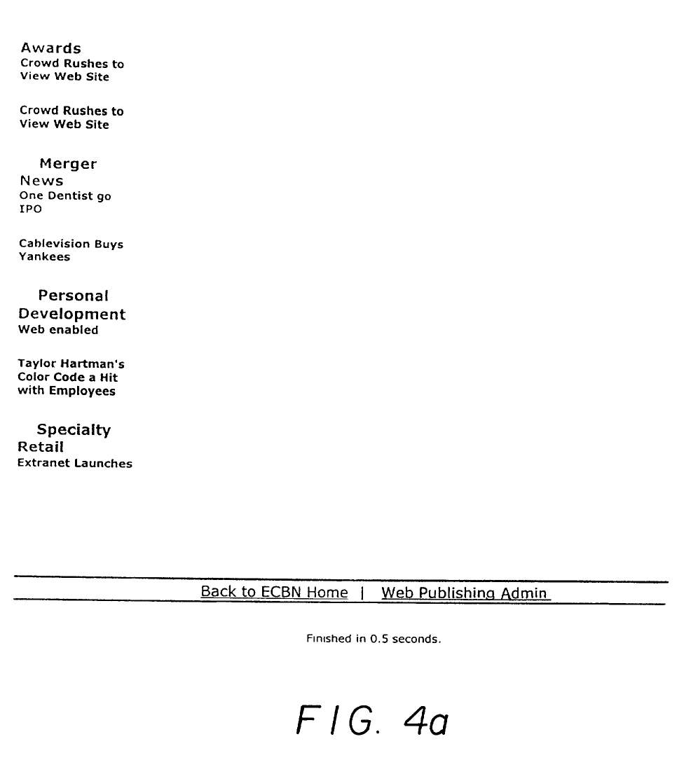

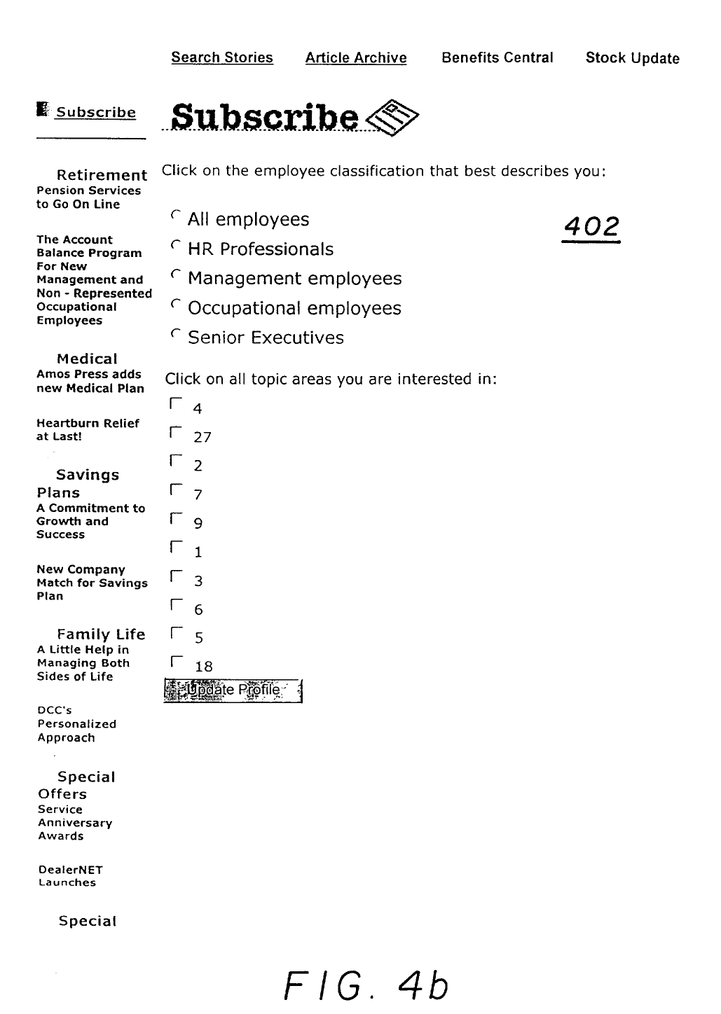

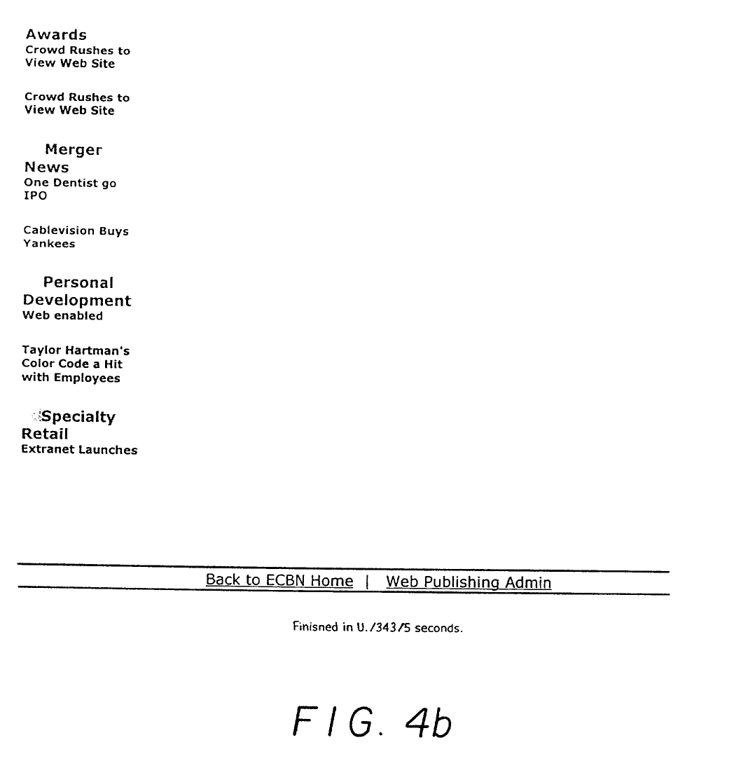

The flow chart web page shown respectively in FIGS. 4 and 4a show the subscribe page 400. When the user selects the subscribe page, the user is prompted to enter an e-mail address 401. Once that is done, the software displays a list of all of the categories and audiences 402. An audience is a type of user. The audience can be used solely for distribution lists or to restrict access to particular articles to members of the specified audience. After the user selects which categories and audiences to subscribe to, the database entries for those distribution lists are updated 403. The subscribe page also enables the user to set up links. At step 405, the user can link to the website's main page. In addition, links can be to a category page 406 on to the website administration 407.

The web pages illustrated in FIG. 4a and FIG. 4b are depictions of the web pages described for FIG. 4. FIG. 4a is the prompt for an e-mail address 401 and FIG. 4b is the list of categories and audiences function 402.

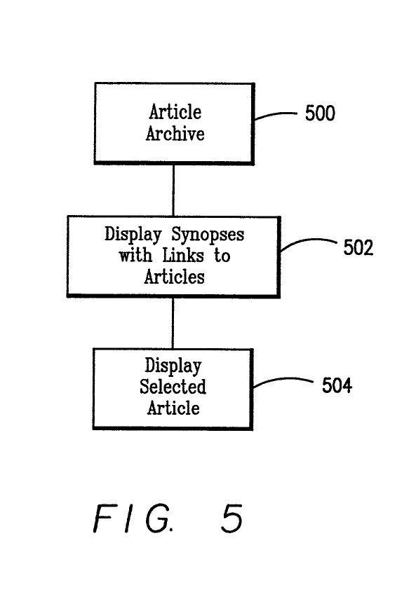

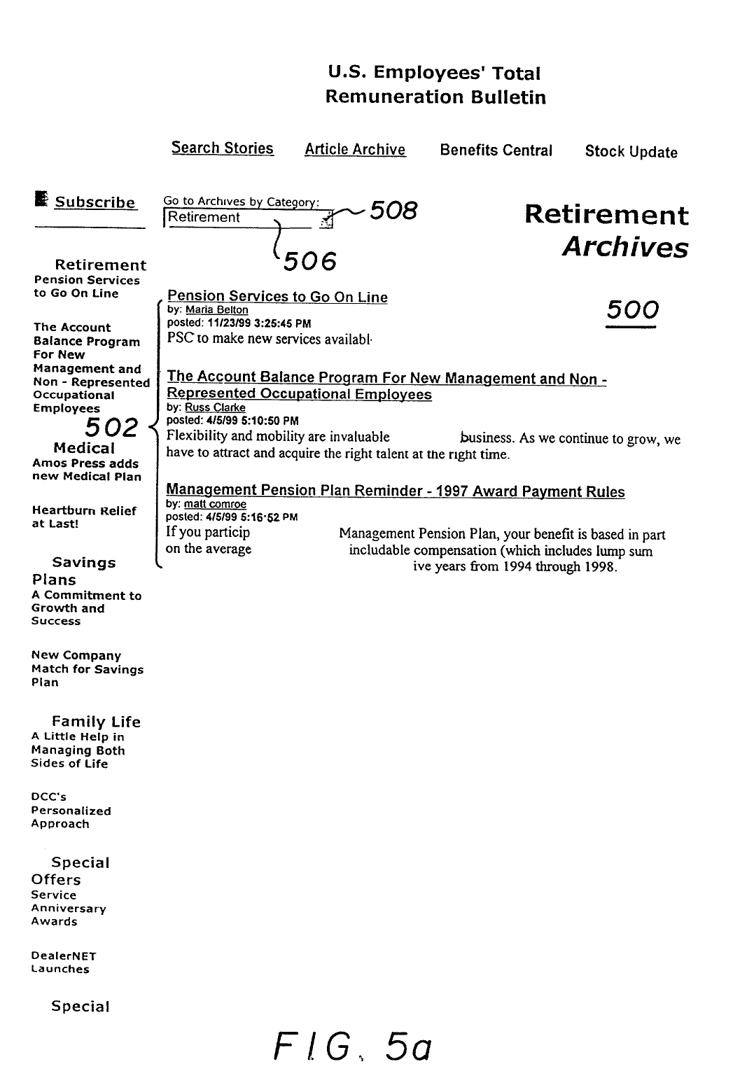

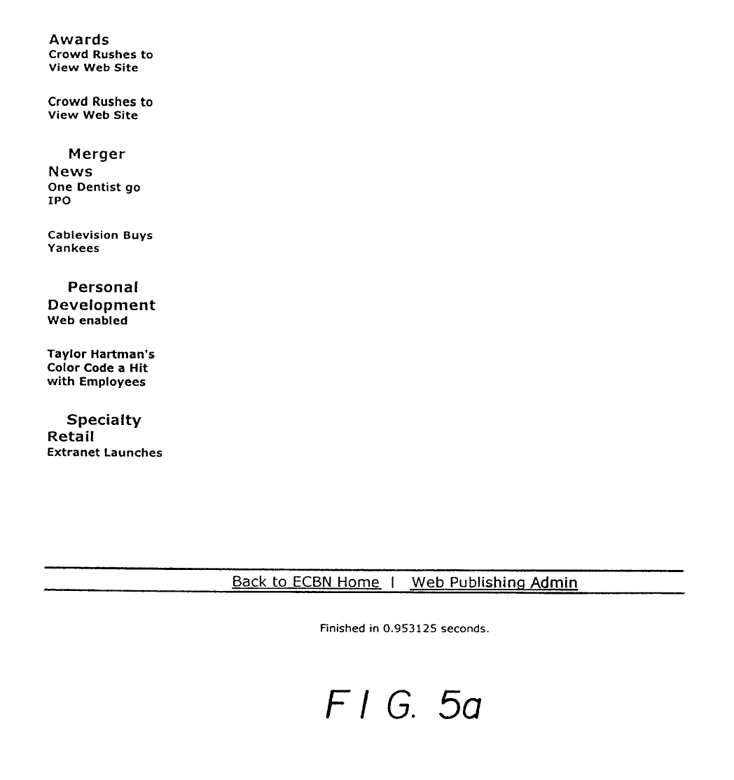

The web page shown in FIG. 5 is the article archive page. This page differs from the category page in that when it is selected, the default category displayed is all categories. This page displays a brief abstract 502 of the article with a direct link to the full-text version. If a hypertext link is activated, then the user can review the entire article at step 504.

The web page illustrated in FIG. 5a is a depiction of the article archive page 500 described for FIG. 5. The categories shown in FIG. 4B are described as topic areas, with numeric designations for specific topics. Any categorization scheme can be employed.

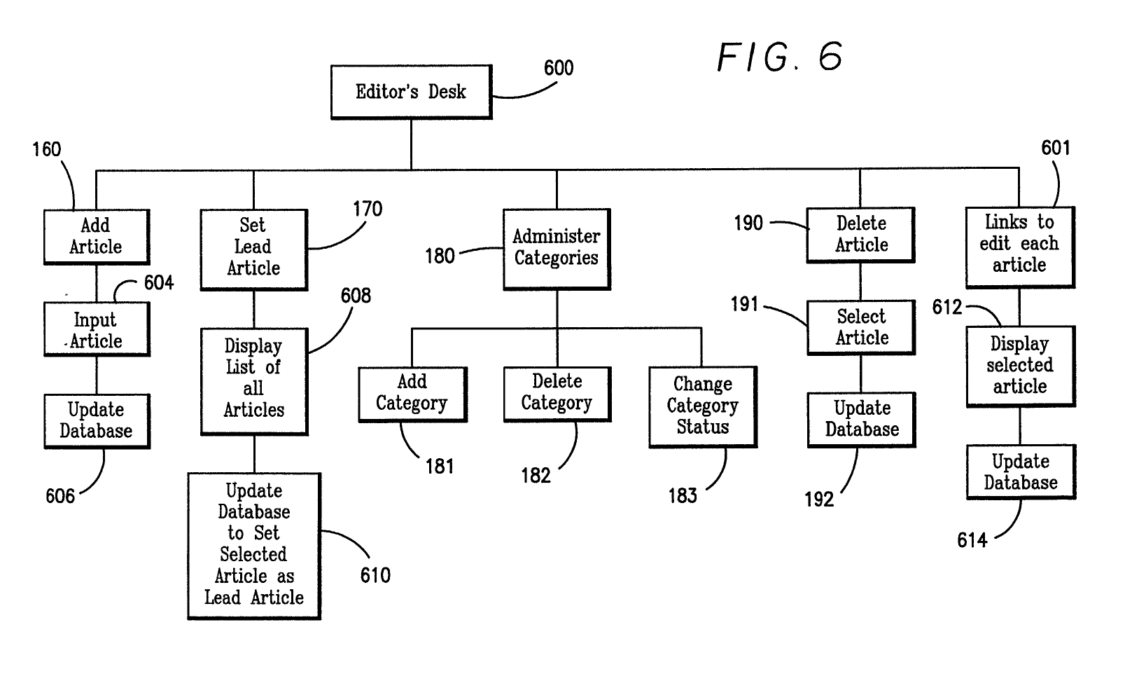

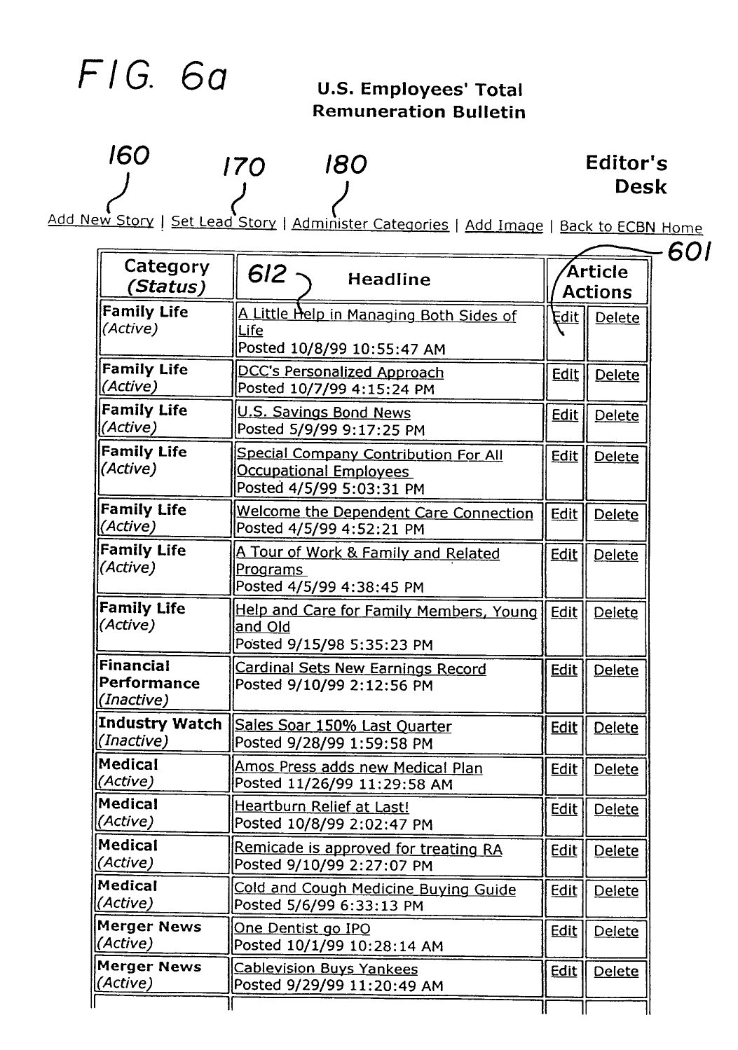

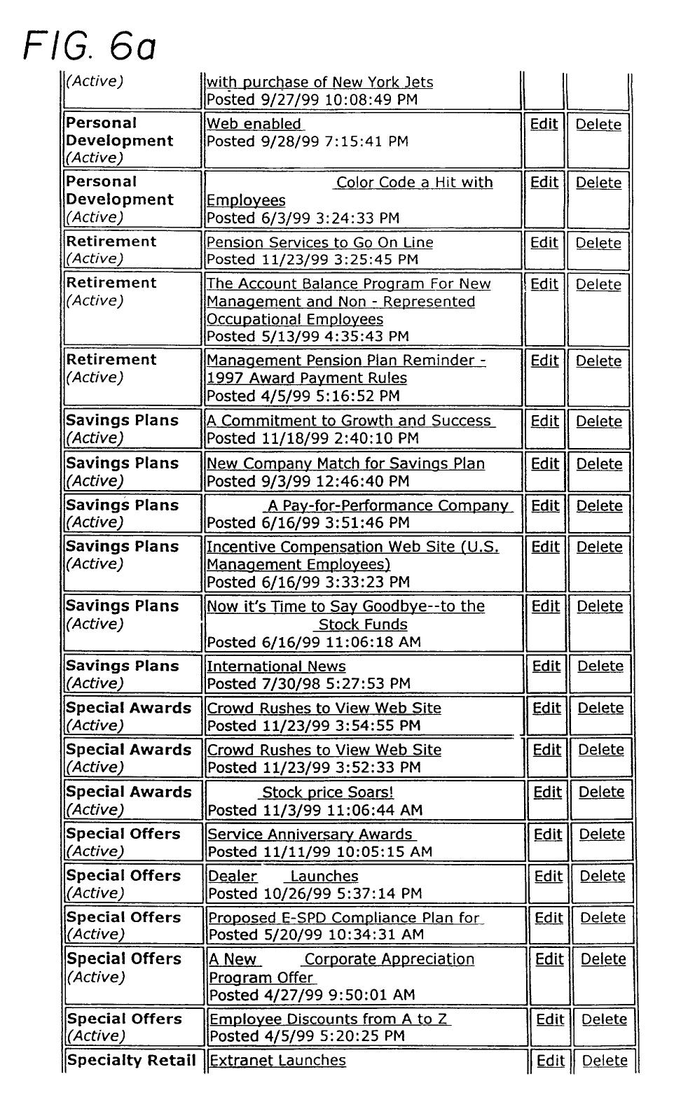

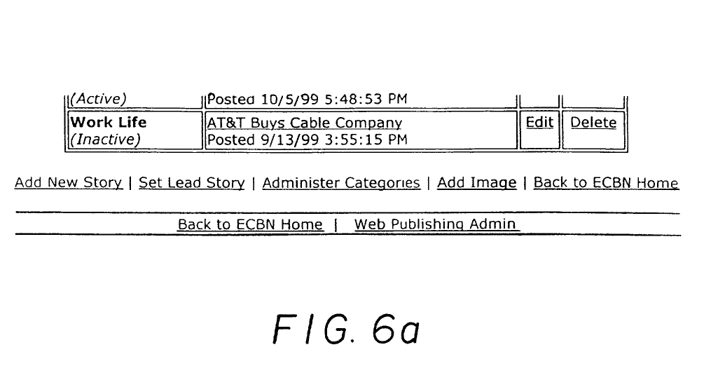

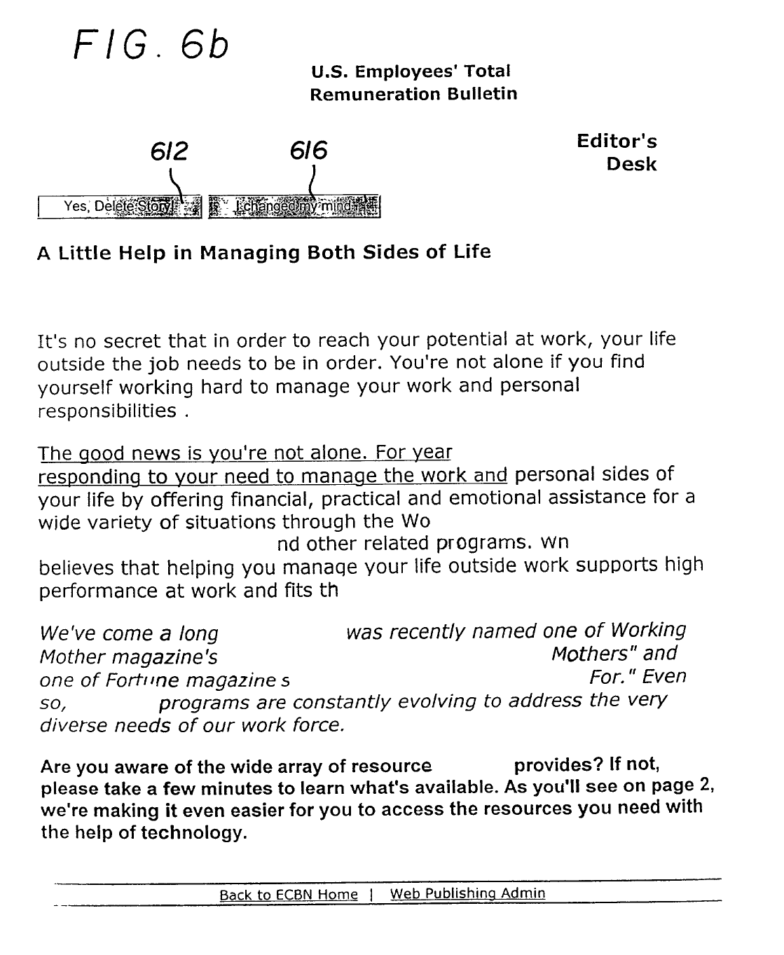

The page shows the capability of going to an archive based on a searched category 506. A drop down menu 508 of all the categories is provided. The list of abstracted articles with hypertext links are displayed 502. FIG. 6 illustrates a flow diagram of the editor's desk 140. The editor's desk has links to add an article 160, set a lead article 170, administer the categories 180, delete each article 190, and edit each article 601. When an article is selected to be edited, the add article page 160 is displayed with the information for the selected article already in the fields. Once the user is finished editing the article 604, the database is updated 606.

The set lead article story option 170 can also be chosen by the user in order to build the headline story. When that option is closer, the editor's desk will display a list of all articles available to the editor at step 608. Once the lead article is set, the database is updated and the selected article is chosen as the lead and stored at step 610.

The administrator categories 180 enables the editor to manipulate the various categories affiliated with the news center. The editor can either add a new category 181, delete a category 182 or change the category's status from, for example, active to inactive.

The delete article further 190 is available in the editor's desk when the article, in its entirety, is displayed 191 (see FIG. 6b). The user is a head if he/she wants to delete the story at step 512 [FIG. 6b]. Once the story is deleted, then the database is updated to reflect the change 192.

The web page illustrated in FIG. 6a is a depiction of the web page described for FIG. 6. It has a list of articles with links to edit 601 display a selected article 612 and then update the database 614 or delete 190 each article. It also has links to add a new article 160, set a lead article 170, and administer the categories 180.

The web page illustrated in FIG. 6b is a depiction of the confirmation to delete displayed when the user selects to delete an article. The user can select to either confirm the deletion 612 or to cancel it 616.

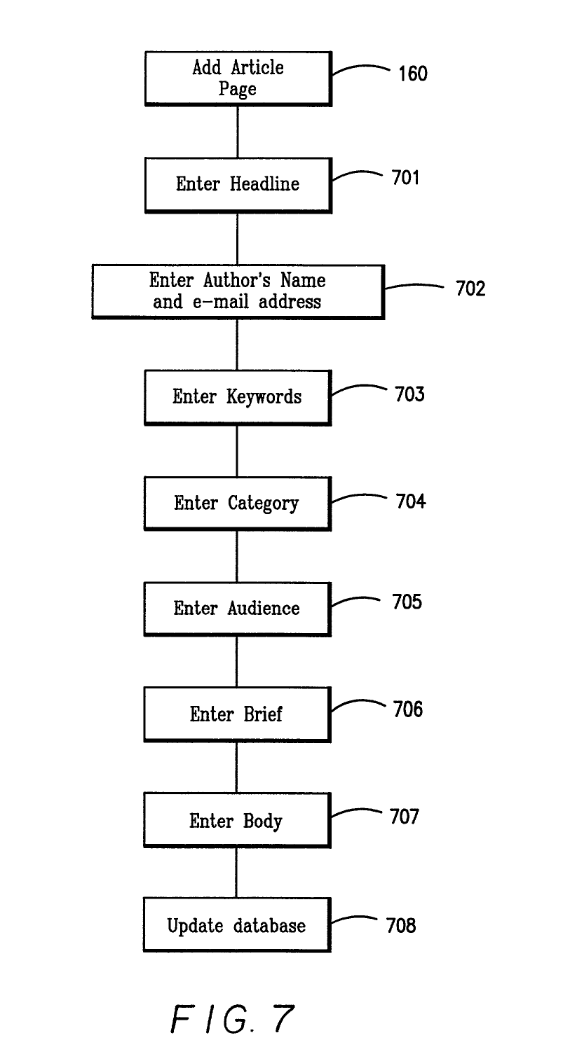

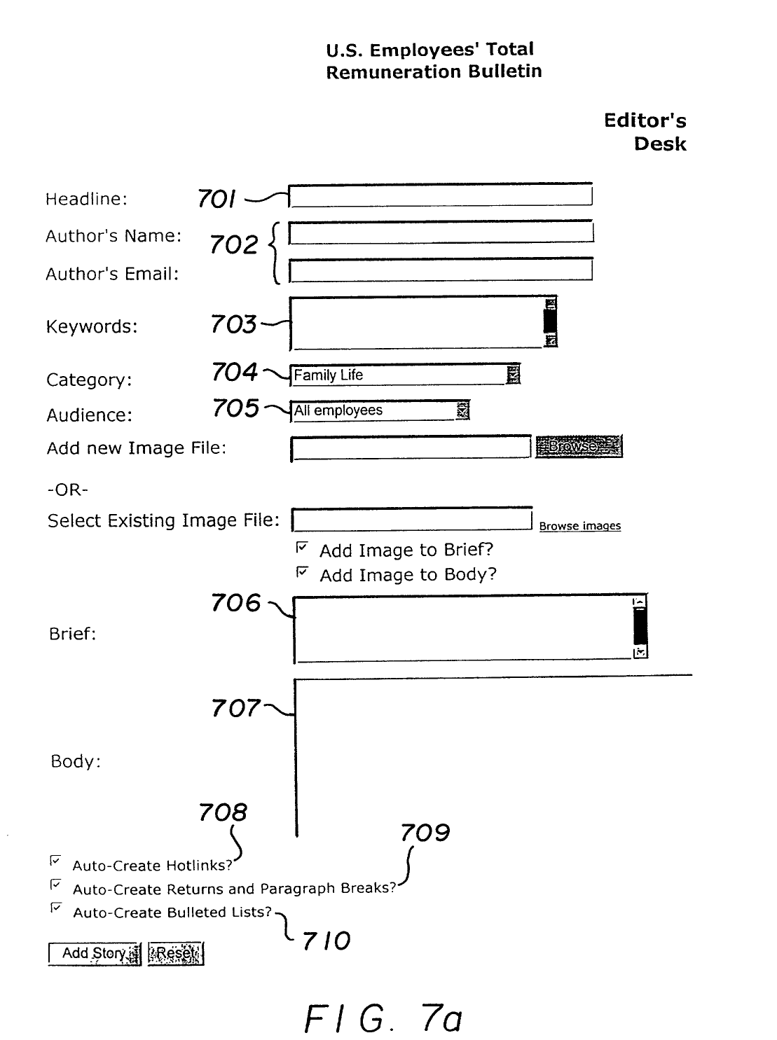

The flow chart shown in FIG. 7 is a more detailed description of the add articles flow chart in FIG. 6. When the user selects the add article link 160, a blank form for an article is displayed. The user is prompted to enter a headline at step 701, the user's name and e-mail address 702, keywords for the article 703. The keywords are later used by the search articles function 110 and step 111 to retrieve articles that the user wants to display. The editor must then select a category 704 for the new article at step 704. At step 705 an audience is designated for the article. Any kind of scheme can be devised to describe the appropriate audience types for the publication. For example, the audience can be “all employee”, “management”, “HR Professionals”, “Engineering”, etc. At step 706, the user's prompted to enter a brief 706 description of the article and enter the body of the article at step 707. Once the user is finished entering this information, the database is updated 708, which will cause the article to be e-mailed to the distribution list for the category and audiences. While an article can be associated with multiple audiences, it can only be associated with one category.

The web page illustrated in FIG. 7a is a depiction of the web page described for FIG. 7. To simplify the administration of the web site, this web page also includes options for the software to auto-create hotlinks 708, auto-create returns and paragraph breaks 709, and auto-create bulleted lists 710. When auto-create hotlinks 708 is selected, the software will search the body of the article for any Internet addresses. If there are any, it will automatically convert them into the HTML format for links in the body of the article when it updates the database. When auto-create returns and paragraph breaks 709 is selected, the software will convert any returns or paragraph breaks in the body of the article into HTML format when it updates the database. When auto-create bulleted lists 710 is selected, the software will convert any bulleted lists in the body of the article into HTML format when it updates the database.

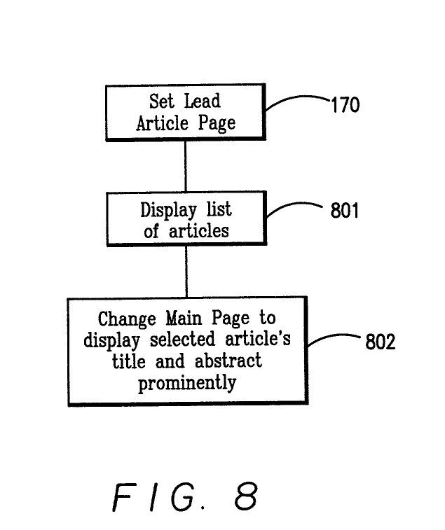

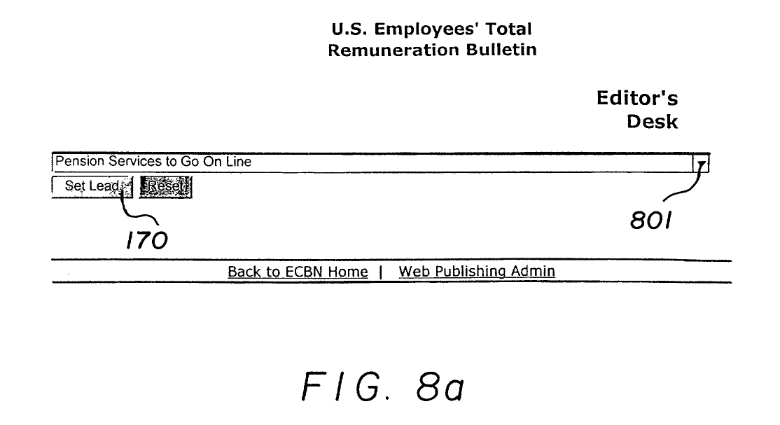

The web page shown in FIG. 8 is the set lead article page 170. When the user selects the set lead article page, a drop-down menu is displayed 801. Every article in the database is listed in the drop-down menu. After the user selects an article, the database is updated and the main page is modified at step 802 so that the lead article is displayed prominently.

The web page illustrated in FIG. 8a is a depiction of the web page described for FIG. 8.

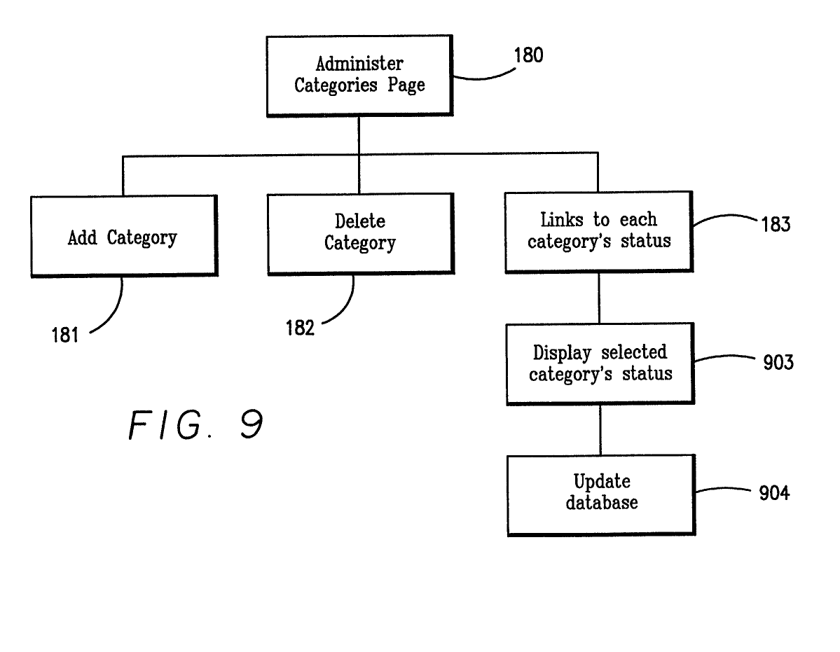

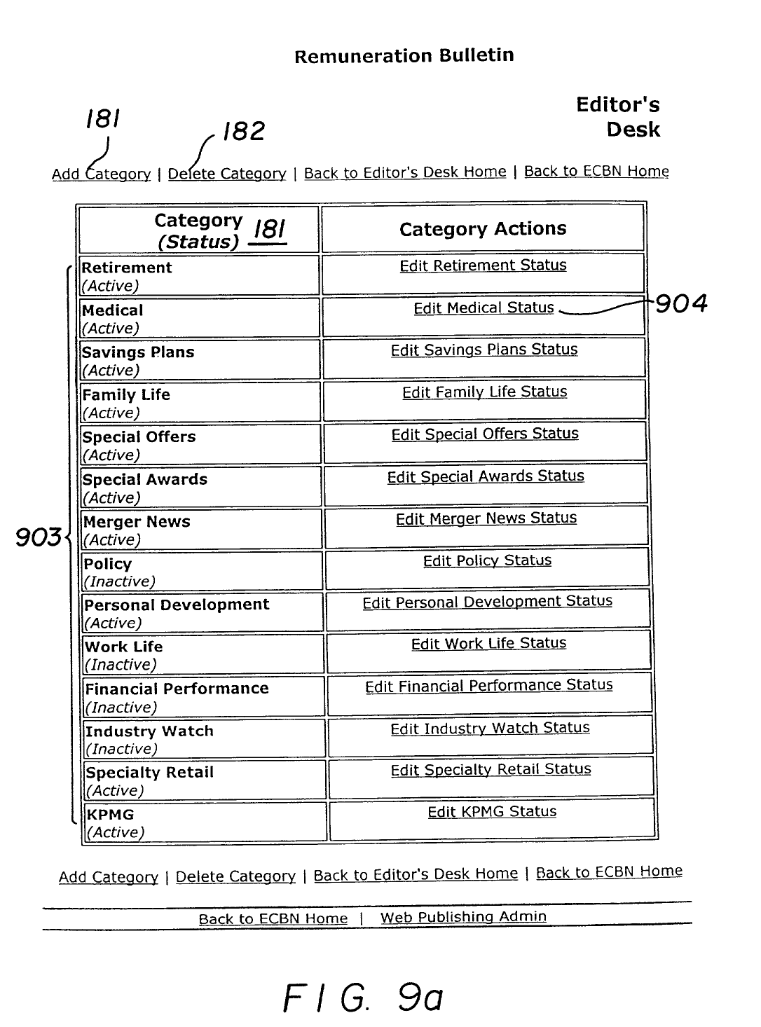

The flow diagram shown in FIG. 9 is the administer categories page 180. It includes links to add a category 181, delete a category 182, and links to edit each category's status. If a category is set to an active status, then any users without administrative access can access the articles in that category or subscribe to a distribution list for it. If a category is inactive, then the articles in that category can only be viewed from the editor's desk 140. When the administer categories link 181 is selected, the software queries the database for a list of all categories and each category's status 903. A table is displayed with each category, its status 903, and link to edit each category's status and update the category status in the databases 904.

The web page illustrated in FIG. 9a is a depiction of the flow chart described for FIG. 9.

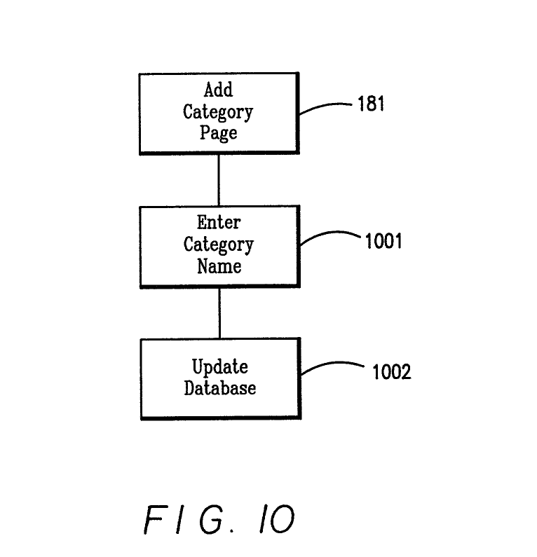

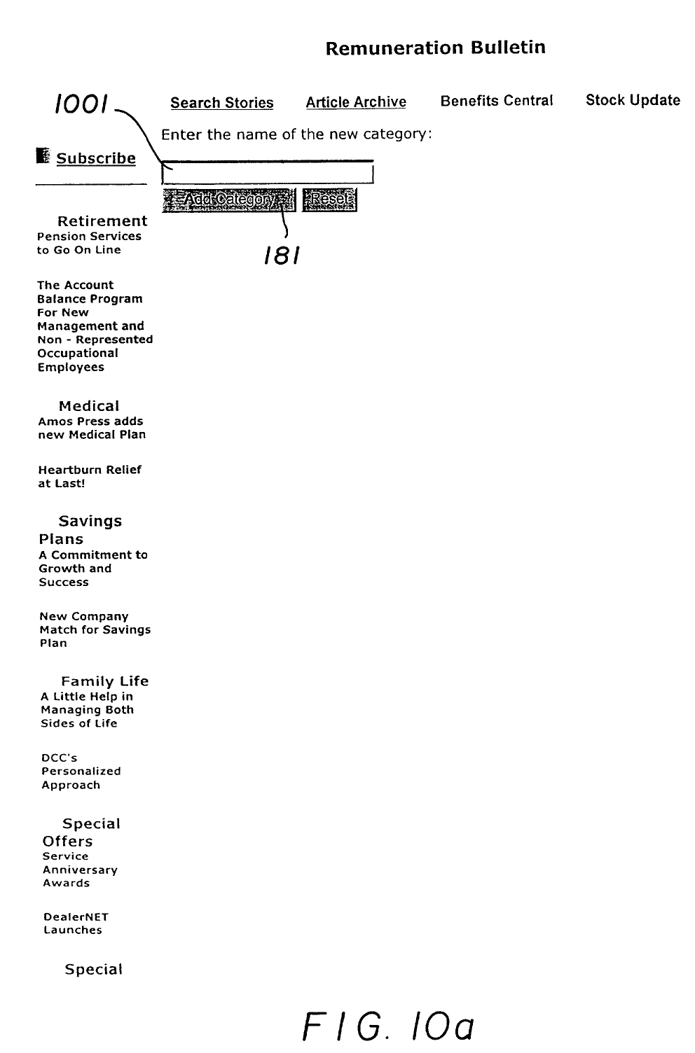

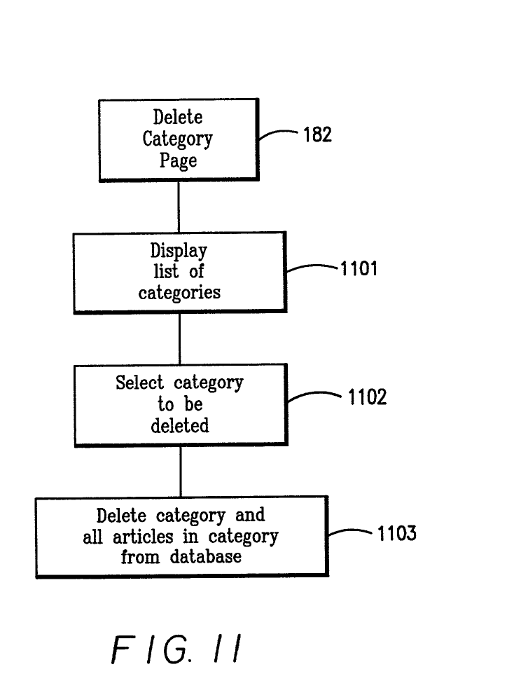

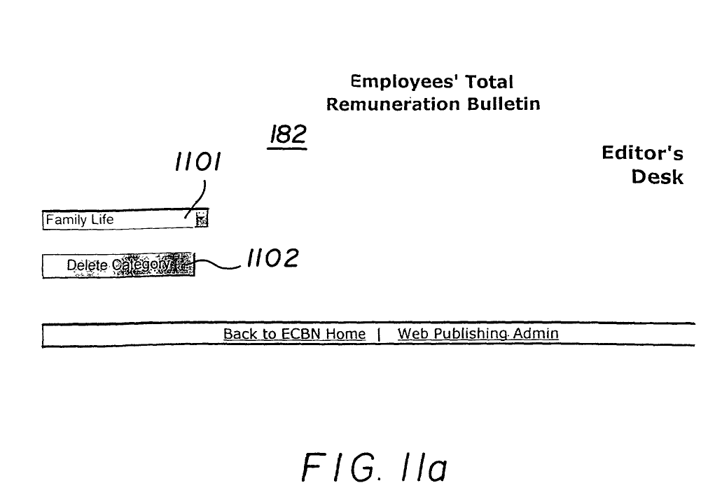

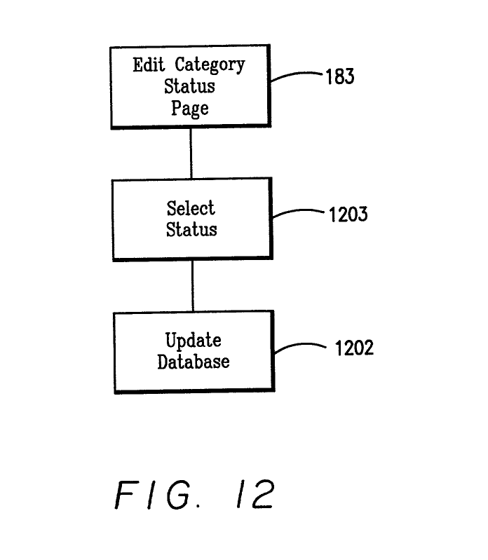

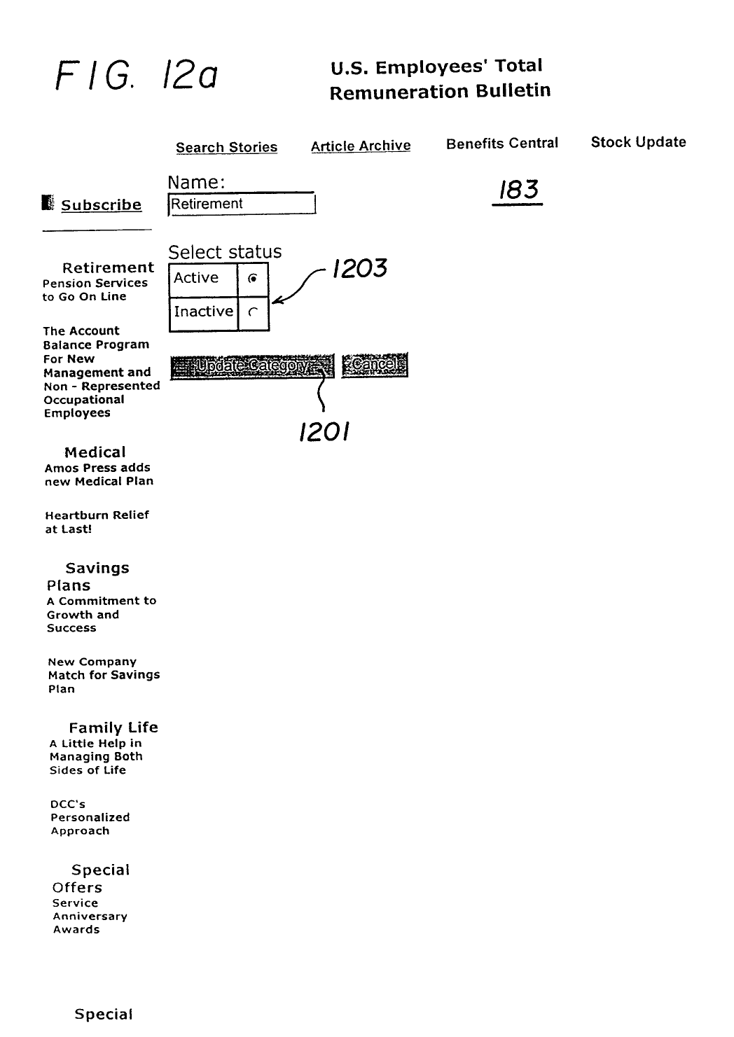

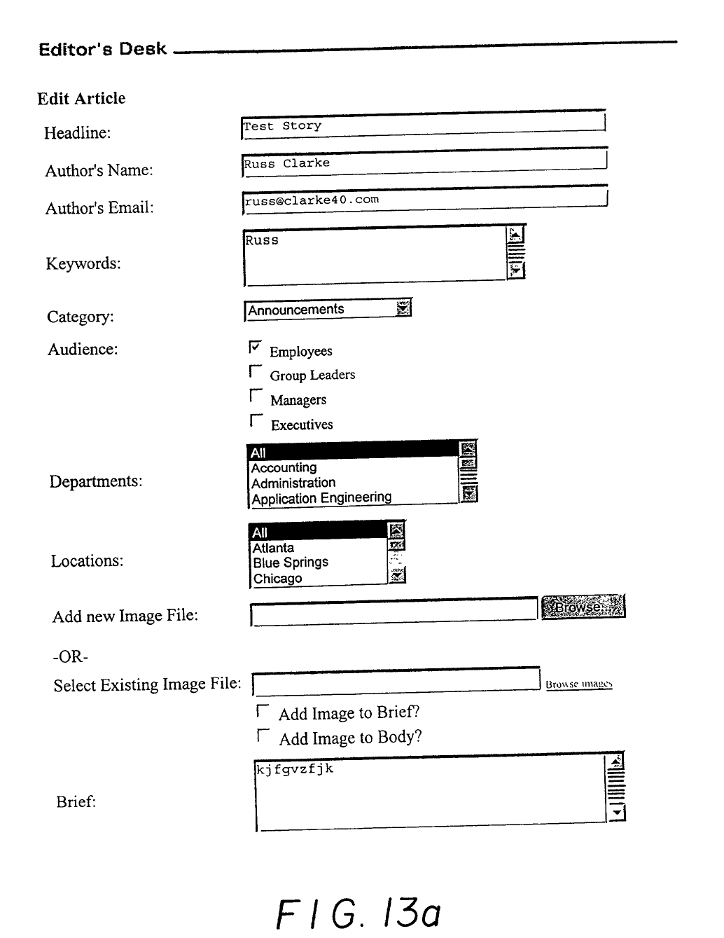

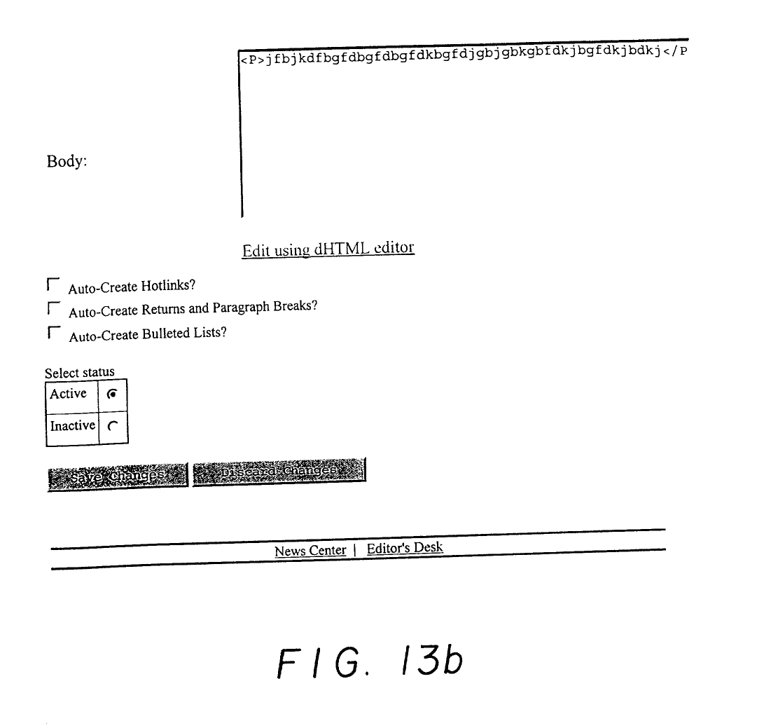

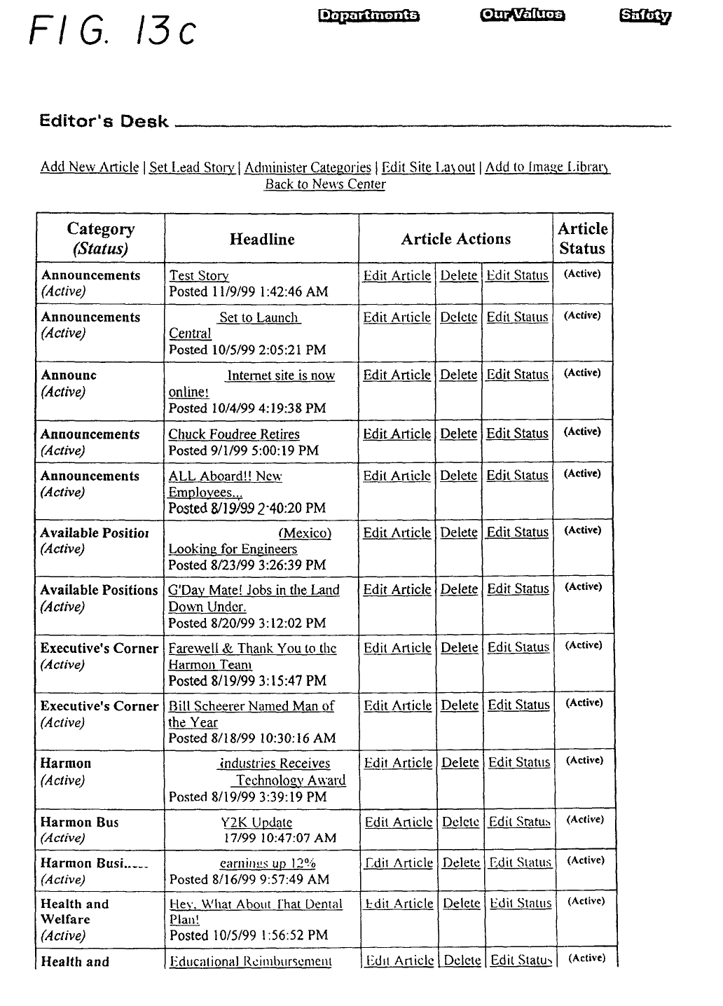

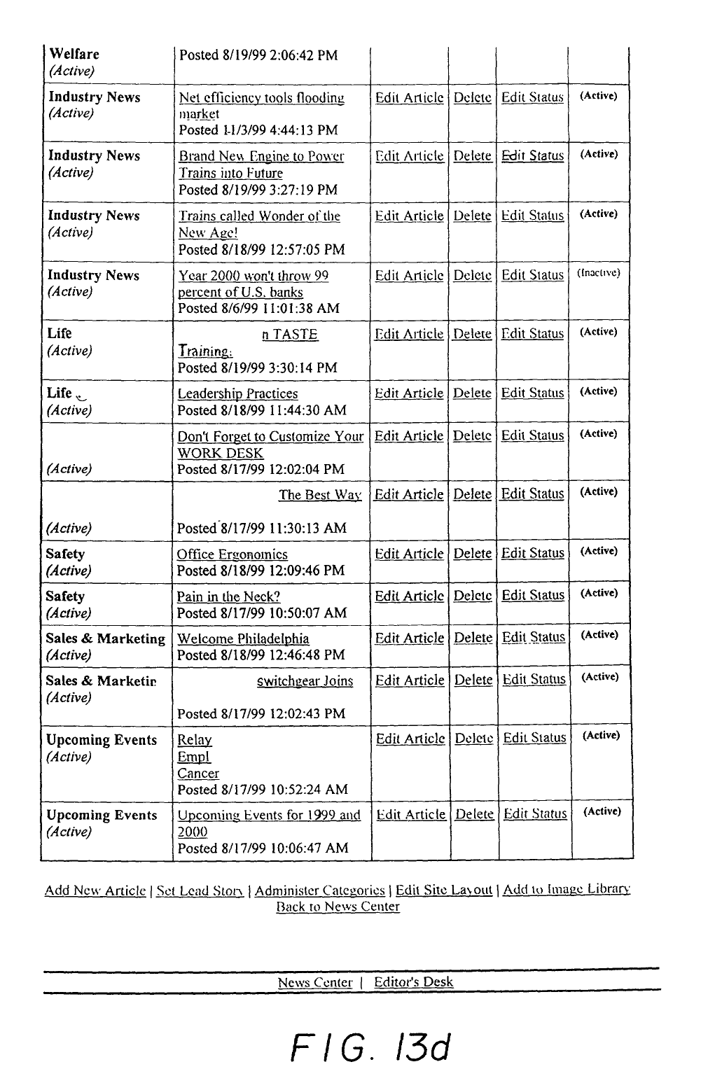

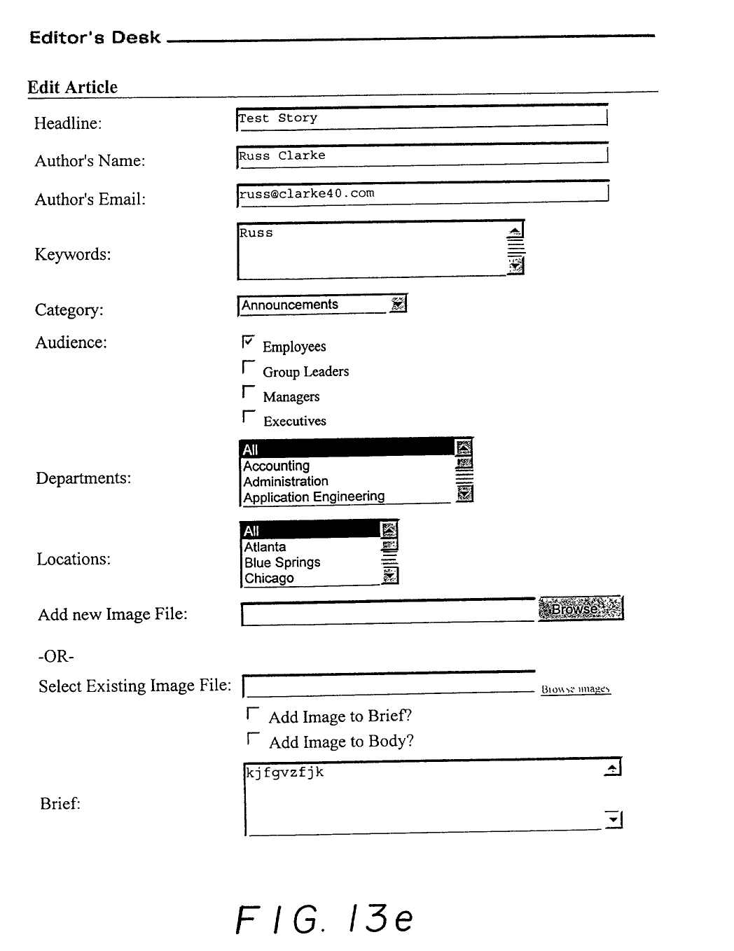

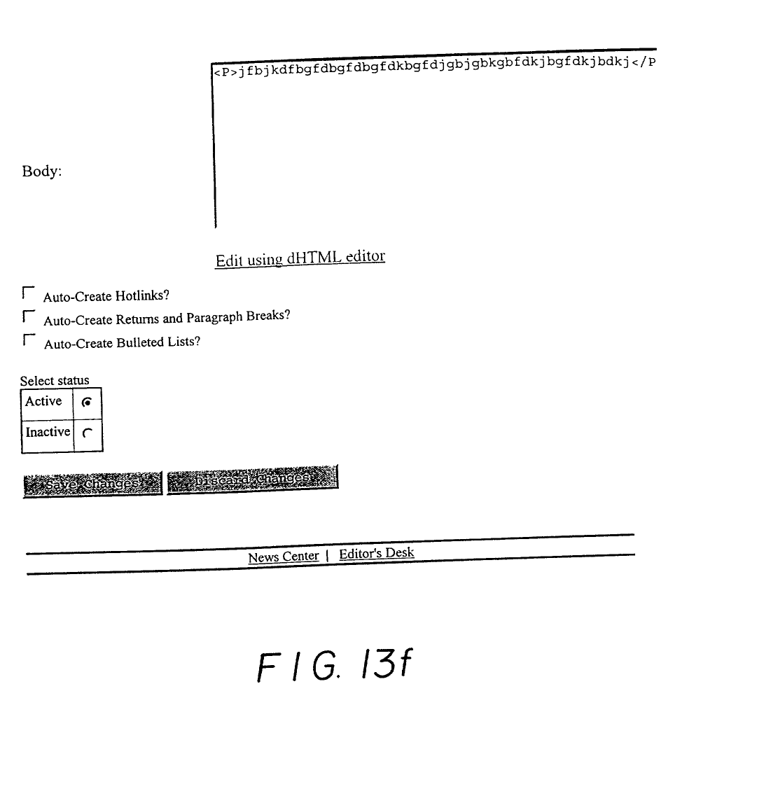

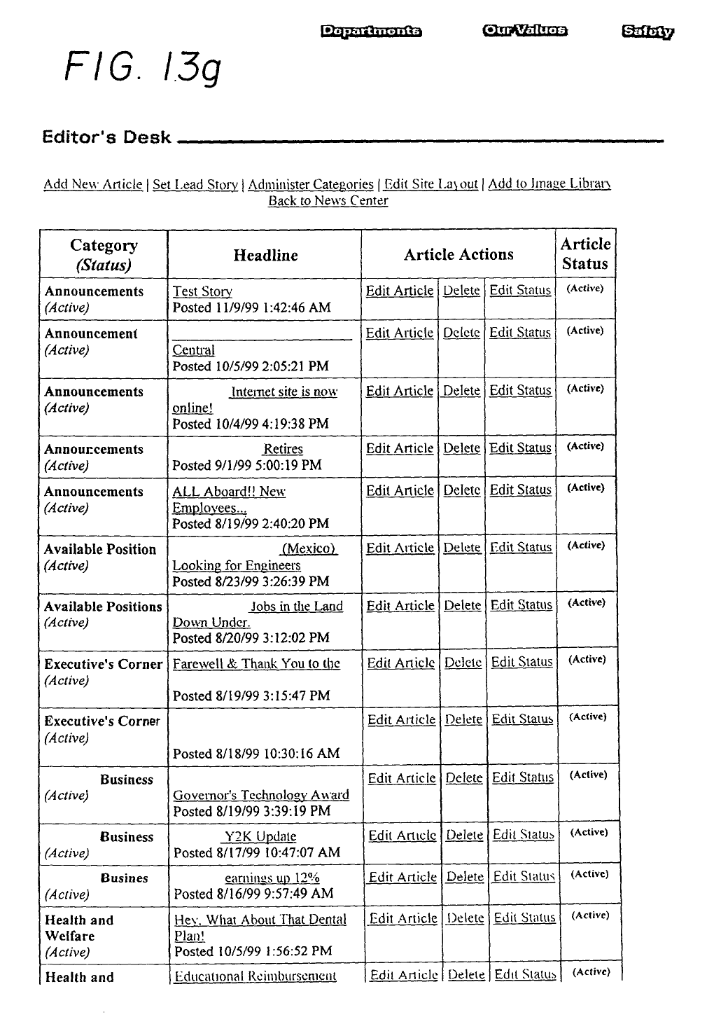

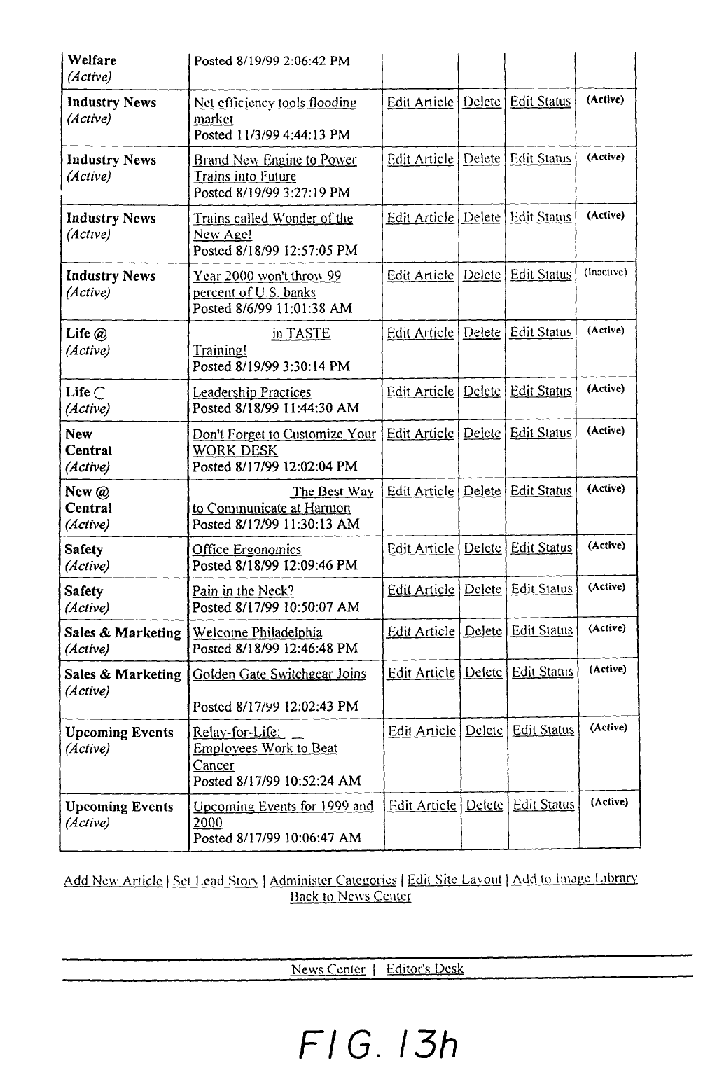

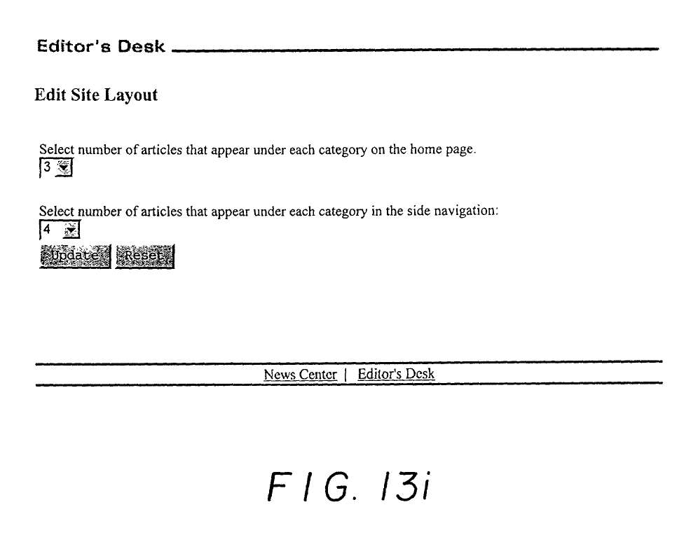

The flow chart shown in FIG. 10 is the add category page 181. When the add category link is selected 181, the user is prompted to enter the name of the new category 1001. The default status of a new category is inactive. Once the user has selected to add the category, the database is updated 1002.

The web page illustrated in FIG. 10a is a depiction of the web page described for FIG. 10.

The web page shown in FIG. 11 is the delete category page 182. When the delete category page is selected, a drop-down menu containing a list of the categories 1101 is displayed. Once the user selects a category to delete 1102, the category, its distribution list, and all of the articles associated with that category are deleted from the database 1103. The main page, and all pages that link to each category, are modified to remove the deleted category.

The web page illustrated in FIG. 11a is a depiction of the web page described for FIG. 11.

The flow chart shown in FIG. 12 is the edit category status page 183. When the edit category status page is selected, the database is queried for the status of the selected category. Then a table with active and inactive is displayed with the current status of the category selected 1203. The user can then select the desired status for the selected category 1201. The database is then updated 1202.

The web page illustrated in FIG. 12a is a depiction of the web page described for FIG. 12.

The invention provides an apparatus and method for allowing a person with limited knowledge of web page design and computer programming to design an online newsletter that a person with minimal knowledge of computers can administer over a computer network. The above description and drawings are only illustrative of preferred embodiments which achieve the objects, features and advantages of the present invention. It is not intended that the present invention be limited to the illustrated embodiments as modifications, substitutions and use of equivalent structures can be made. Accordingly, the invention is not to be considered as limited by the foregoing description, but is only limited by the scope of the appended claims.

What is claimed as new and desired to be protected by Letters Patent of the United States is:

1. A computer system publishing program, said computer system comprising:
a computer memory;
a search processor having a user interface, said interface including a searcher, a subscriber, an articles searcher, a category viewer, an article archive viewer, a headline viewer, and an editor.

2. A computer system as in claim 1, wherein said searcher allows the articles to be searched by text, by category, by abstract or by headlines.

3. A computer system as in claim 1, wherein said subscriber adds e-mail addresses to mailing lists or e-mailing lists.

4. A computer system as in claim 1, wherein said category searcher allows the articles within a category to be searched by text or abstracts.

5. A computer system as in claim 1, wherein said category viewer allows the articles in a category to be viewed.

6. A computer system as in claim 1, wherein said article archive viewer allows old articles to be viewed.

7. A computer system as in claim 1, wherein said headline viewer allows the headlines of the stories to be viewed.

8. A computer system as in claim 1, wherein said editor incorporates an article editor and a category editor.

9. A computer system as in claim 8, wherein said article editor allows an article to be added, deleted or modified or allows an image to be added to an article.

10. A computer system as in claim 8, wherein said category editor allows a category to be added, deleted, modified, or have its status changed.

11. A method of publishing a newsletter on a computer network comprising:
displaying headlines and abstracts of articles;
displaying category listings that reference each category;
displaying article archives that reference each article in the archive;
searching articles by keywords;
subscribing e-mail address to mailing lists;
adding, modifying, and deleting articles;
converting added and modified articles into HTML; and
adding, modifying, or removing any references to an article when it is added, modified, or deleted.
